(19) United States
(12) Patent Application Publication
(10) Pub. No.: US 2024/0155505 A1
(43) Pub. Date: May 9, 2024

(54) METHOD AND APPARATUS FOR SIDELINK COMMUNICATION IN UNLICENSED BAND

(71) Applicant: ELECTRONICS AND TELECOMMUNICATIONS RESEARCH INSTITUTE, Daejeon (KR)

(72) Inventors: Jun Hyeong KIM, Daejeon (KR); Go San NOH, Daejeon (KR); Seon Ae KIM, Daejeon (KR); Il Gyu KIM, Daejeon (KR); Hee Sang CHUNG, Daejeon (KR); Dae Soon CHO, Daejeon (KR); Sung Woo CHOI, Daejeon (KR); Seung Nam CHOI, Daejeon (KR); Jung Pil CHOI, Daejeon (KR)

(21) Appl. No.: 18/499,114

(22) Filed: Oct. 31, 2023

(30) Foreign Application Priority Data
Oct. 31, 2022 (KR) 10-2022-0142356

(51) Int. Cl. H04W 52/24; H04W 52/42

(52) U.S. Cl. CPC H04W 52/245; H04W 52/242; H04W 52/42

(57) ABSTRACT

A method of a first user equipment (UE) may comprise: receiving a downlink (DL) reference signal transmitted by a base station using a beam included in a beam candidate group to be used for sidelink (SL) communication with a second UE; measuring a DL reference signal received power (RSRP) of the DL reference signal; determining a transmit power of a beam included in the beam candidate group based on the measured DL RSRP; and transmitting SL data to the second UE with the determined transmit power.

### CROSS-REFERENCE TO RELATED APPLICATION

This application claims priority to Korean Patent Application No. 10-2022-0142356, filed on Oct. 31, 2022, with the Korean Intellectual Property Office (KIPO), the entire contents of which are hereby incorporated by reference.

### BACKGROUND

### 1. Technical Field

Exemplary embodiments of the present disclosure relate to a sidelink communication technique, and more specifically, to a sidelink communication technique in an unlicensed band.

### 2. Related Art

Vehicle-to-Everything (V2X) is a communication technology for exchanging various information including traffic information with other vehicles and other infrastructures such as roads through wired/wireless networks. The V2X includes communication between vehicles (Vehicle-to-Vehicle, V2V), communication between a vehicle and a road infrastructure/network (Vehicle-to-Infrastructure/Network, V2I/N), and communication between a vehicle and a pedestrian (Vehicle-to-Pedestrian, V2P). As an example of V2X communication services, vehicles within a certain range can exchange their own location/speed information and surrounding traffic situation information through V2V communication to prevent sudden traffic accidents, or a platoon driving service can be provided in which a plurality of vehicles connected through V2V communication drive in a convoy on a highway. In addition, by providing high-speed wireless backhaul services to vehicles through V2I/N communication, users in the vehicles can use high-speed Internet services and drive/control the vehicles remotely using V2I/N wireless networks.

Meanwhile, active sidelink standardization activities are underway in the release-18 (Rel-18) of the 3^{rd} generation partnership project (3GPP). Starting at the RAN1#109-e meeting in May 2022, the standardization activity for a 3 GPP's Rel-18 sidelink work item (‘NR sidelink evolution’) has begun. The work item includes standardization efforts for supporting sidelink operations in unlicensed bands, and it encompasses the following two standardization items.

The first standardization item is an unlicensed band sidelink channel access mechanism (design baseline: NR-U channel access mechanism). The second standardization item is the design of unlicensed band sidelink physical channels.

Accordingly, unlicensed communication methods for satisfying the above-described work items for unlicensed band sidelink communication are required.

### SUMMARY

Exemplary embodiments of the present disclosure are directed to providing an unlicensed band sidelink communication method.

According to a first exemplary embodiment of the present disclosure, a method of a first user equipment (UE) may comprise: receiving a downlink (DL) reference signal transmitted by a base station using a beam included in a beam candidate group to be used for sidelink (SL) communication with a second UE; measuring a DL reference signal received power (RSRP) of the DL reference signal; determining a transmit power of a beam included in the beam candidate group based on the measured DL RSRP; and transmitting SL data to the second UE with the determined transmit power.

The method may further comprise: transmitting an SL reference signal to the second UE; and receiving information on an SL RSRP for the SL reference signal from the second UE, wherein the information on the SL RSRP received from the second UE is further considered in determining the transmit power of the beam included in the beam candidate group.

When the beam candidate group includes a plurality of beams, the measuring of the DL RSRP may further comprise: measuring DL RSRP(s) for all beams included in the beam candidate group or one or more beams from the beam candidate group, measuring a DL RSRP for an arbitrary one beam selected among the beams included in the beam candidate group, measuring a DL RSRP of a beam most recently used in SL communication, or measuring a DL RSRP for a beam to be used for the SL communication.

In the measuring of the DL RSRP using the beam included in the beam candidate group, measurement may be performed within a preconfigured measurement window.

In the measuring of the DL RSRP using the beam included in the beam candidate group with in a preconfigured measurement window, when a number of measurements of the RSRP of the DL reference signal is less than a preset number, transmit powers of beams included in the beam candidate group may be determined by using a preset DL path loss (PL) value or a most recently applied DL PL value.

The method may further comprise: determining whether multi-consecutive slot transmission (MCSt) is to be performed based on a Listen-Before-Talk (LBT) procedure during SL communication with the second UE in an unlicensed band; in response to determining to perform the MCSt, determining a number of transport blocks (TBs) to be transmitted in consecutive slots; identifying whether flexible symbols of each slot are allocatable as a resource for transmitting the TB when performing the MCSt; and in response to determining that the flexible symbols are allocatable, transmitting the TB to the second UE using at least a portion of the flexible symbols, wherein the flexible symbols includes a guard symbol of a first slot and an automatic gain control (AGC) symbol of a second slot when the first slot and the second slot are temporally consecutive in performing the MCSt.

A case when the flexible symbols are allocatable may correspond to a case when first SL data to be transmitted by the first UE has a higher priority than a predetermined threshold priority.

A case when the flexible symbols are not allocatable may correspond to a case when a data priority of a TB transmitted by a neighboring third UE is higher than a priority of the first SL data.

When performing the MCSt, a reference position of a second starting symbol in the first slot may be preconfigured by higher-layer signaling.

When the flexible symbols are included in the resource for transmitting the TB, a size of the TB (TBS) may be calculated including the flexible symbols.

The method may further comprise, when at least one subchannel among one or more subchannels through which the TB is transmitted overlaps with at least a portion of a guard band (GB), determining a size of the TB (TBS) by including a size of physical resource blocks (PRBs) included in the GB in calculating the TBS.

According to a second exemplary embodiment of the present disclosure, a first user equipment (UE) may comprise a processor, and the processor may cause the first UE to perform: receiving a downlink (DL) reference signal transmitted by a base station using a beam included in a beam candidate group to be used for sidelink (SL) communication with a second UE; measuring a DL reference signal received power (RSRP) of the DL reference signal; determining a transmit power of a beam included in the beam candidate group based on the measured DL RSRP; and transmitting SL data to the second UE with the determined transmit power.

The processor may further cause the first UE to perform: transmitting an SL reference signal to the second UE; and receiving information on an SL RSRP for the SL reference signal from the second UE, wherein the information on the SL RSRP received from the second UE is further consider in determining the transmit power of the beam included in the beam candidate group.

When the beam candidate group includes a plurality of beams, in the measuring of the DL RSRP, the processor may further cause the first UE to perform: measuring DL RSRP(s) for all beams included in the beam candidate group or one or more beams from the beam candidate group, measuring a DL RSRP for an arbitrary one beam selected among the beams included in the beam candidate group, measuring a DL RSRP of a beam most recently used in SL communication, or measuring a DL RSRP for a beam to be used for the SL communication.

In the measuring of the DL RSRP using the beam included in the beam candidate group with in a preconfigured measurement window, the processor may further cause the first UE to perform, when a number of measurements of the RSRP of the DL reference signal is less than a preset number, determining transmit powers of beams included in the beam candidate group by using a preset DL path loss (PL) value or a most recently applied DL PL value.

The processor may further cause the first UE to perform: determining whether multi-consecutive slot transmission (MCSt) is to be performed based on a Listen-Before-Talk (LBT) procedure during SL communication with the second UE in an unlicensed band; in response to determining to perform the MCSt, determining a number of transport blocks (TBs) to be transmitted in consecutive slots; identifying whether flexible symbols of each slot are allocatable as a resource for transmitting the TB when performing the MCSt; and in response to determining that the flexible symbols are allocatable, transmitting the TB to the second UE using at least a portion of the flexible symbols, wherein the flexible symbols includes a guard symbol of a first slot and an automatic gain control (AGC) symbol of a second slot when the first slot and the second slot are temporally consecutive in performing the MCSt.

A case when the flexible symbols are allocatable may correspond to a case when first SL data to be transmitted by the first UE has a higher priority than a predetermined threshold priority.

A case when the flexible symbols are not allocatable may correspond to a case when a data priority of a TB transmitted by a neighboring third UE is higher than a priority of the first SL data.

The processor may further cause the first UE to perform, when at least one subchannel among one or more subchannels through which the TB is transmitted overlaps with at least a portion of a guard band (GB), determining a size of the TB (TBS) by including a size of physical resource blocks (PRBs) included in the GB in calculating the TBS.

The processor may further cause the first UE to perform, when the flexible symbols are included in the resource for transmitting the TB, calculating a size of the TB (TBS) including the flexible symbols.

According to exemplary embodiments of the present disclosure, provides are methods for controlling a UE's transmit power in beamforming-based SL communication, allocating consecutive slot resources for a UE in an unlicensed band, and determining a transport block size. Additionally, according to the present disclosure, a first UE can receive a DL reference signal transmitted by a base station using a beam included in a beam candidate group for SL communication with a second UE, measure a DL RSRP, and determine a transmit power of the beam included in the beam candidate group based on that. Accordingly, there is the advantage of not only reducing interference but also enabling effective beam power control for SL communication.

### BRIEF DESCRIPTION OF DRAWINGS

FIG. 1 is a conceptual diagram illustrating a first exemplary embodiment of a communication system.

FIG. 2 is a block diagram illustrating a first embodiment of a communication node constituting a communication system.

FIG. 3A is a conceptual diagram illustrating types of sidelink communication according to the present disclosure.

FIG. 3B is a conceptual diagram illustrating broadcast-based, groupcast-based, and unicast-based sidelink communications provided by NR V2X.

FIG. 4A is a conceptual diagram illustrating a case where 11 subchannels constitute a bandwidth part in sidelink.

FIG. 4B is a conceptual diagram illustrating a partial configuration of consecutive slots in one sidelink subchannel.

FIG. 4C is a conceptual diagram illustrating the remaining configuration of the consecutive slots in the one sidelink subchannel.

FIG. 5 is a conceptual diagram illustrating an NR SL transmit power control method based on a downlink path loss and a sidelink path loss.

FIG. 6 is a conceptual diagram illustrating LBT-based downlink and uplink communications.

FIG. 7A is a conceptual diagram illustrating a case of DL signal reception and SL signal transmission at a UE when not using a beam.

FIG. 7B is a conceptual diagram illustrating a case of DL signal reception and SL signal transmission at a UE when using a beam.

FIG. 8 is a conceptual diagram illustrating starting symbol positions in the SL-U time domain.

FIG. 9 is a conceptual diagram illustrating a case in which one TB is transmitted when MCSt is performed in the time domain of NR SL-U.

FIG. 10 is a conceptual diagram illustrating a case in which two TBs are transmitted when MCSt is performed in the time domain of SL-U.

FIG. 11A is a conceptual diagram illustrating a first exemplary embodiment of resource allocation in initial transmission and retransmission of NR SL-U.

FIG. 11B is a conceptual diagram illustrating a second exemplary embodiment of resource allocation in initial transmission and retransmission of NR SL-U.

FIG. 11C is a conceptual diagram illustrating a third exemplary embodiment of resource allocation in initial transmission and retransmission of NR SL-U.

### DETAILED DESCRIPTION OF THE EMBODIMENTS

While the present disclosure is capable of various modifications and alternative forms, specific exemplary embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular exemplary embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE- Advanced network, 5G mobile communication network, or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

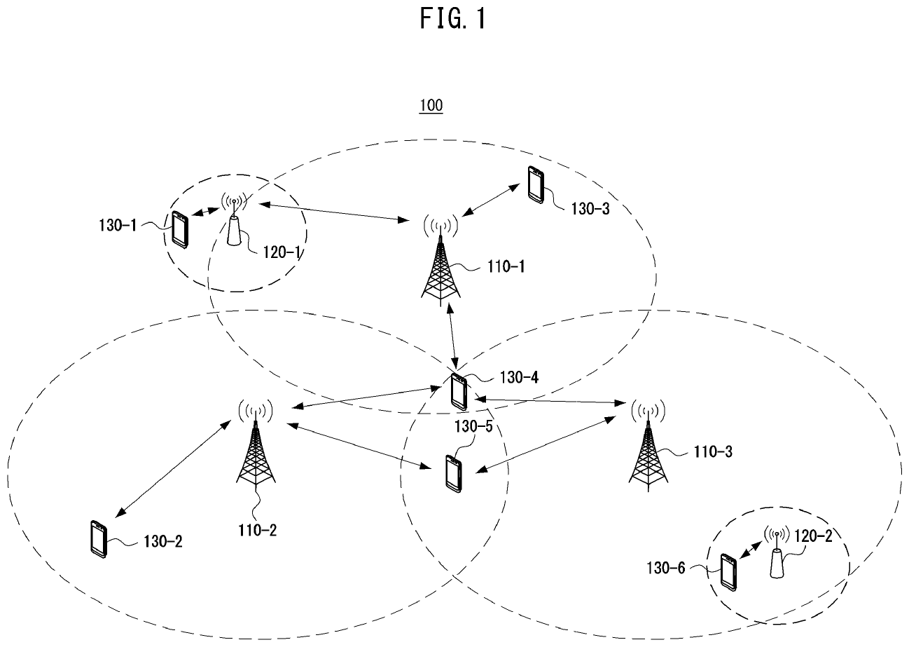

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4th generation (4G) communication (e.g., long term evolution (LTE), LTE-advanced (LTE-A)), 5th generation (5G) communication (e.g., new radio (NR)), or the like. The 4G communication may be performed in a frequency band of 6 gigahertz (GHz) or below, and the 5G communication may be performed in a frequency band of 6 GHz or above as well as the frequency band of 6 GHz or below.

For example, for the 4G and 5G communications, the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

In addition, the communication system 100 may further include a core network. When the communication system 100 supports the 4G communication, the core network may comprise a serving gateway (S-GW), a packet data network (PDN) gateway (P-GW), a mobility management entity (MME), and the like. When the communication system 100 supports the 5G communication, the core network may comprise a user plane function (UPF), a session management function (SMF), an access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

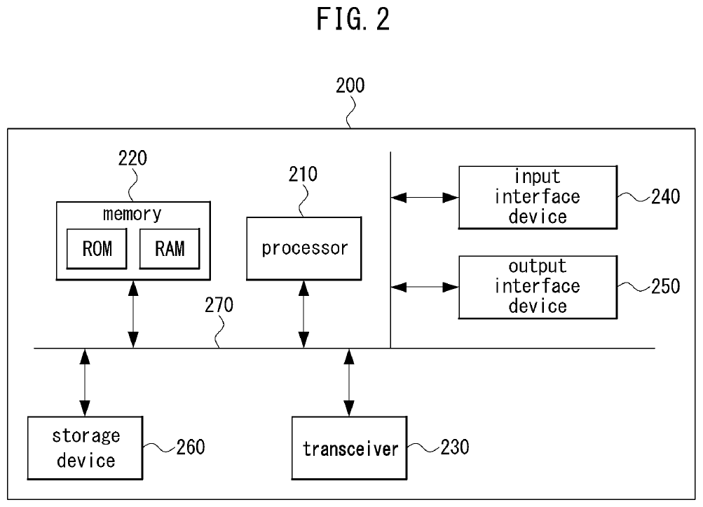

FIG. 2 is a block diagram illustrating a first embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, an evolved Node-B (eNB), a base transceiver station (BTS), a radio base station, a radio transceiver, an access point, an access node, a road side unit (RSU), a radio remote head (RRH), a transmission point (TP), a transmission and reception point (TRP), an eNB, a gNB, or the like.

Here, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, an Internet of things (IoT) device, a mounted apparatus (e.g., a mounted module/device/terminal or an on-board device/terminal, etc.), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g., a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for configuring and managing radio interfaces in a communication system will be described. Even when a method (e.g., transmission or reception of a data packet) performed at a first communication node among communication nodes is described, the corresponding second communication node may perform a method (e.g., reception or transmission of the data packet) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g., remote radio transmission/reception function, baseband processing function, and the like) of a communication protocol. Alternatively, the remote radio transmission/reception function among all the functions of the communication protocol may be performed by a transmission reception point (TRP) (e.g., flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

Hereinafter, sidelink communication will be described. Vehicle-to-Everything (V2X) is a communication technology for exchanging various information including traffic information with other vehicles and other infrastructures such as roads through wired/wireless networks. The V2X includes communication between vehicles (Vehicle-to-Vehicle, V2V), communication between a vehicle and a road infrastructure/network (Vehicle-to-Infrastructure/Network, V2I/N), and communication between a vehicle and a pedestrian (Vehicle-to-Pedestrian, V2P). As an example of V2X communication services, vehicles within a certain range can exchange their own location/speed information and surrounding traffic situation information through V2V communication to prevent sudden traffic accidents, or a platoon driving service can be provided in which a plurality of vehicles connected through V2V communication drive in a convoy on a highway. In addition, by providing high-speed wireless backhaul services to vehicles through V2I/N communication, users in the vehicles can use high-speed Internet services and drive/control the vehicles remotely using V2I/N wireless networks.

In various wireless communication systems including the 3GPP 4G long term evolution (LTE), a device-to-device (D2D) communication scheme, in which terminals can communicate directly with each other without passing through a network node, has been adopted to support the V2X services and various other wireless communication services. In case of 3GPP, a direct communication link between terminal is defined as a sidelink (SL). In the case of LTE, communication between terminals is possible through a sidelink even when out of network coverage, and the LTE sidelink communication has been initially standardized for D2D communication purposes in the LTE release-12. Thereafter, there were many standardization efforts in the 3GPP to improve sidelinks suitable for V2X communications.

In various wireless communication systems including the 3GPP 4G long term evolution (LTE), a device-to-device (D2D) communication scheme, in which terminals can communicate directly with each other without passing through a network node, has been adopted to support the V2X services and various other wireless communication services. In the case of 3GPP, a direct communication link between terminal is defined as a sidelink (SL). In the case of LTE, communication between terminals is possible through a sidelink even when out of network coverage, and the LTE sidelink communication has been initially standardized for D2D communication purposes in the LTE release-12. Thereafter, the 3GPP has additionally designed the LTE sidelink to be suitable for V2X communication and introduced it into the standard.

In June 2018, the 3GPP completed the 5G NR release-15 standardization and began standardizing the NR V2X corresponding to the 3GPP V2X phase 3, at the RAN1#94 meeting in August 2018. The NR V2X supports improved V2X services in addition to the existing LTE-based V2X services. Rather than replacing the services provided by the LTE V2X, the NR V2X seeks to support improved V2X services by complementing and linking with the LTE V2X. Therefore, the NR V2X should meet higher requirements than the LTE V2X.

The NR V2X release-16 standardization has been conducted primarily with a focus on sidelink design. As described above, a sidelink is a communication link that allows data packets to be exchanged directly between terminals without going through a network. Basically, V2V and V2P links may be sidelinks. In addition, a V2I link between a vehicle and an infrastructure that supports functions of terminals may also correspond to a sidelink. Such configuration will be described with reference to the accompanying drawings.

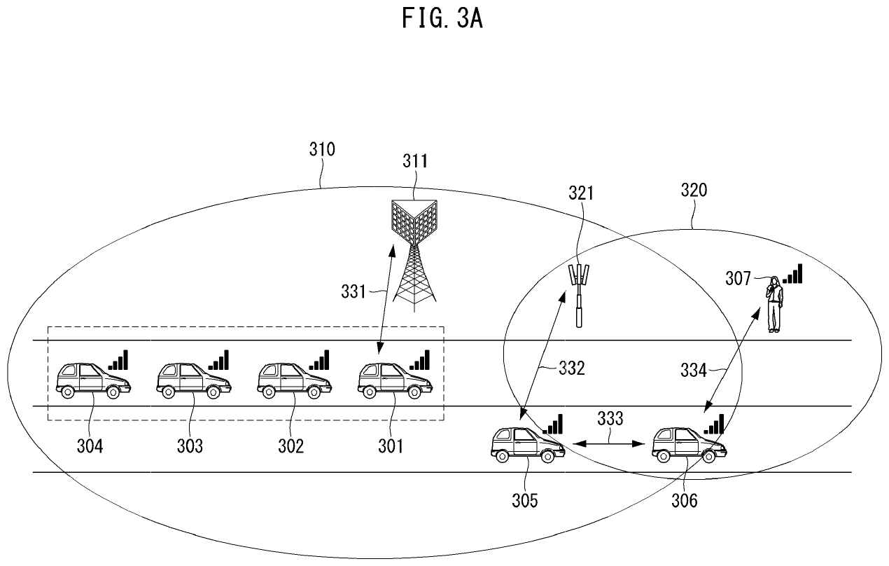

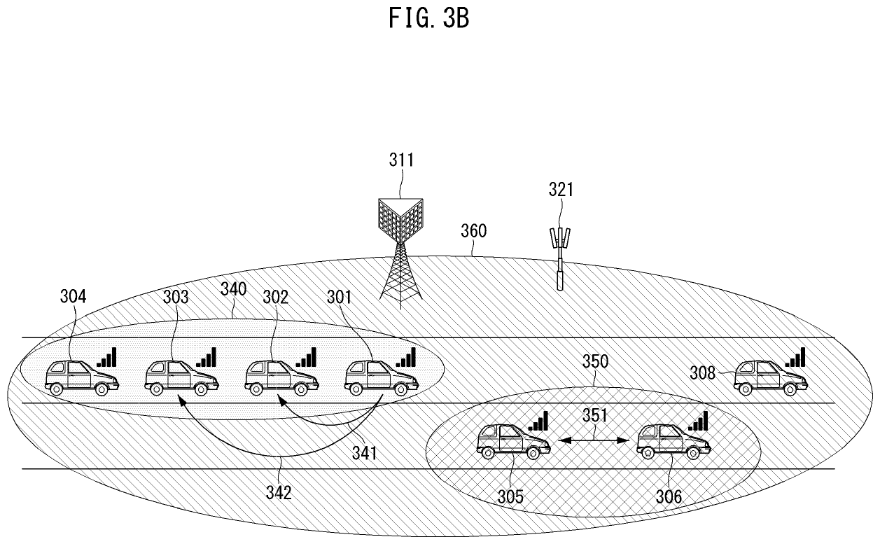

FIG. 3A is a conceptual diagram illustrating types of sidelink communication according to the present disclosure.

Referring to FIG. 3A, a base station (BS) 311 may have a base station coverage 310. A plurality of vehicle terminals 301, 302, 303, 304, 305, and 306 may be located within the base station coverage 310. In addition, a road side unit (RSU) 321 may have an RSU coverage 320 based on a sidelink communication scheme. A plurality of terminals 305, 306, and 307 may be located within the RSU coverage 320. FIG. 3A illustrates a user who possesses the terminal 307 capable of sidelink communication with the vehicle terminals 301, 302, 303, 304, 305, and 306 driving on a road. The vehicle terminal may be a terminal mounted on a vehicle (or attached to a vehicle, or carried or worn by a driver or passenger of a vehicle). For convenience of description, these vehicle terminals 301 to 306 will be referred to as vehicles. In addition, for convenience of description, a pedestrian who possesses (or carry or wear) the terminal 307 capable of sidelink communication will be referred to as a pedestrian or user. In addition, since FIG. 3A is a diagram for describing sidelink communication according to the present disclosure, only parts related to sidelink communication will be described. Hereinafter, various sidelink communications will be described.

Communication between the base station 311 and the vehicle 301 may be referred to as Vehicle-to-Network (V2N) communication 331. The V2N communication 331 may consist of downlink (DL) from the base station 311 to the vehicle 301 and uplink (UL) from the vehicle 301 to the base station 311.

Communication between the RSU 321 and the vehicle 305 may be referred to as Vehicle-to-Infrastructure (V2I) communication 332. The V2I communication 332 may consist of DL, UL, and/or sidelink (SL).

Communication between the vehicle 305 and the vehicle 306 may be referred to as Vehicle-to-Vehicle (V2V) communication 333. The V2V communication 333 is performed in a scheme of performing direct communication between the vehicles, and various data may be transmitted and received between the vehicles without control of a base station or RSU.

Communication between the vehicle 306 and the pedestrian 307 may be referred to as Vehicle-to-Pedestrian (V2P) communication 334. The V2P communication between the vehicle 306 and the pedestrian 307 may refer to communication between a high-speed moving entity and a low-speed moving entity walking. In addition, the V2P communication 334 may include communication between pedestrians or communication between users riding low-speed vehicles such as cars and bicycles.

FIG. 3B is a conceptual diagram illustrating broadcast-based, groupcast-based, and unicast-based sidelink communications provided by NR V2X.

Comparing FIG. 3B with FIG. 3A, a new vehicle 308 is illustrated instead of the user 307, the coverage of the base station 311 is not illustrated, and the coverage of the RSU 321 is not illustrated. All other components have the same form.

A broadcast communication region 360 for broadcast-based sidelink communication mainly provided by LTE V2X, which is illustrated in FIG. 3B, may be a region where beacon frames are transmitted by a specific communication device. In addition, NR V2X has introduced unicast-based and groupcast-based sidelink communications to support a wider variety of V2X services in addition to the broadcast-based sidelink communication.

Meanwhile, the NR V2X was distributed as a part of the 5G NR release-16 technical specification distributed in January 2020. The NR V2X has introduced unicast-based and groupcast-based sidelink communications to support a wider variety of V2X services in addition to the broadcast-based sidelink communication.

FIG. 3B exemplifies a groupcast communication region 340 of a group to which the vehicles 301, 302, 303, and 304 belong, and a unicast communication region 350 for unicast communication between the vehicle terminals 305 and 306.

A case where the vehicle 301 transmits data (i.e., 341 and 342) to other vehicles 302 and 303 in the groupcast scheme within the groupcast communication region 340 may be considered. In particular, the form illustrated in FIG. 3B may be a form of vehicle platooning. In the case of vehicle platooning, the leading vehicle 301 in a group of vehicles moving together may adjust distances between vehicles by transmitting sidelink messages to the other vehicles 302 and 303. In FIG. 3B, a case where the vehicle 301, which is a terminal within the group, transmits data to the vehicles 302 and 303 within the groupcast communication region 340 is illustrated, but a terminal outside the group may transmit data to the vehicles 301 to 304 within the group through groupcast communication.

In addition, in case of unicast communication, the vehicles 305 and 306 may exist within the unicast communication region 350 and may communicate with each other. Accordingly, in the NR V2X system, messages may be transmitted and received directly between the vehicles 305 and 306, that is, between the terminals, through unicast communication. In other words, the NR V2X system allows terminals to exchange messages directly through unicast communication. In addition, the NR V2X system allows in-group or out-group terminals to deliver messages to terminals formed as a group through groupcast communication.

The main features of the release-16 sidelink technical specifications are as follows.

The NR sidelink uses the same OFDM scheme as UL and DL between a base station and a terminal. In addition, the NR sidelink supports numerologies μ∈{0,1,2,3}. One of the differences between SL and DL/UL is that a resource allocation unit is a subchannel rather than a resource block (RB). A subchannel consists of one or more RBs, and the number of subchannels may be preconfigured. A transport block (TB) may be transmitted on a physical sidelink shared channel (PSSCH) that occupies one or more subchannels.

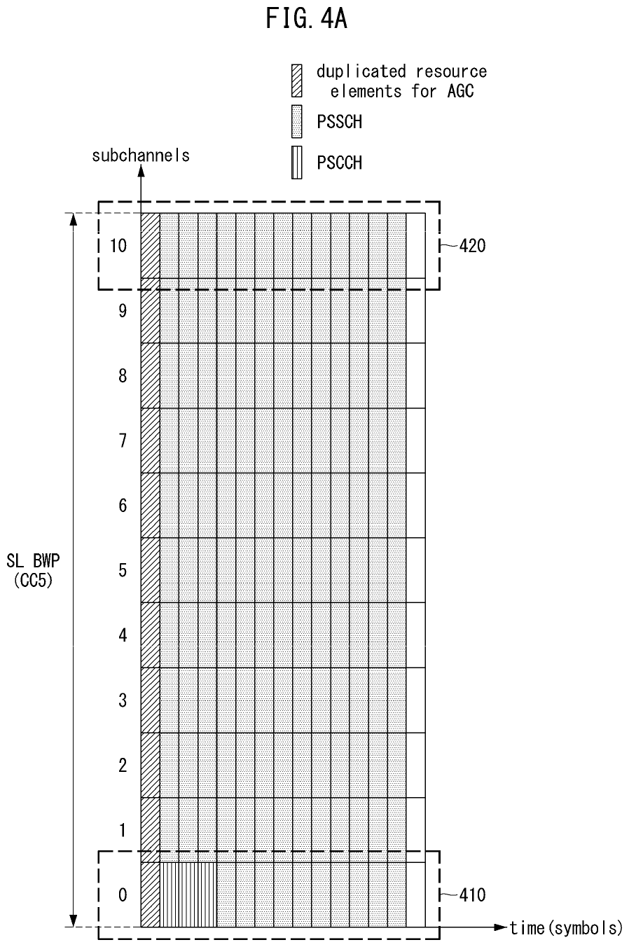

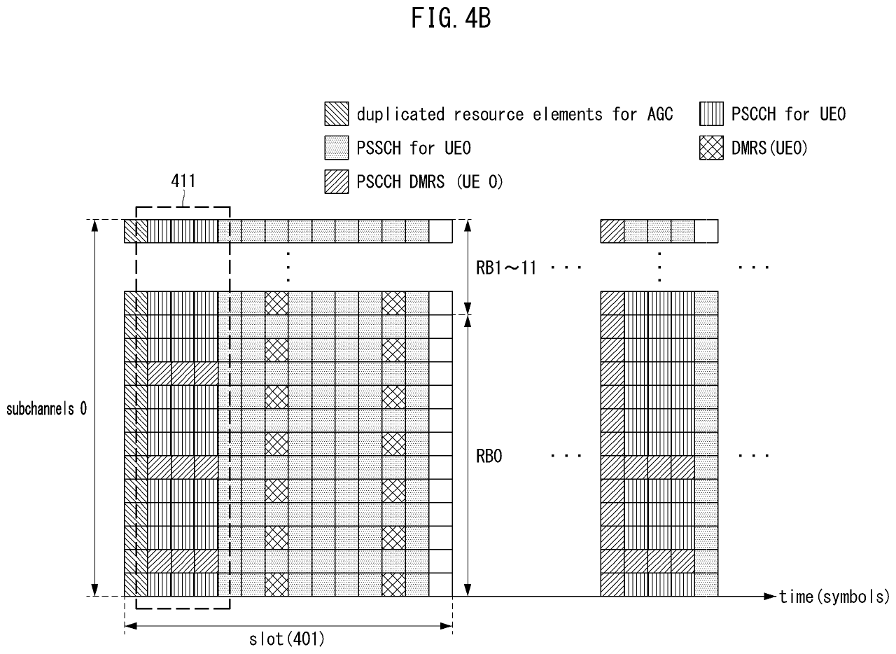

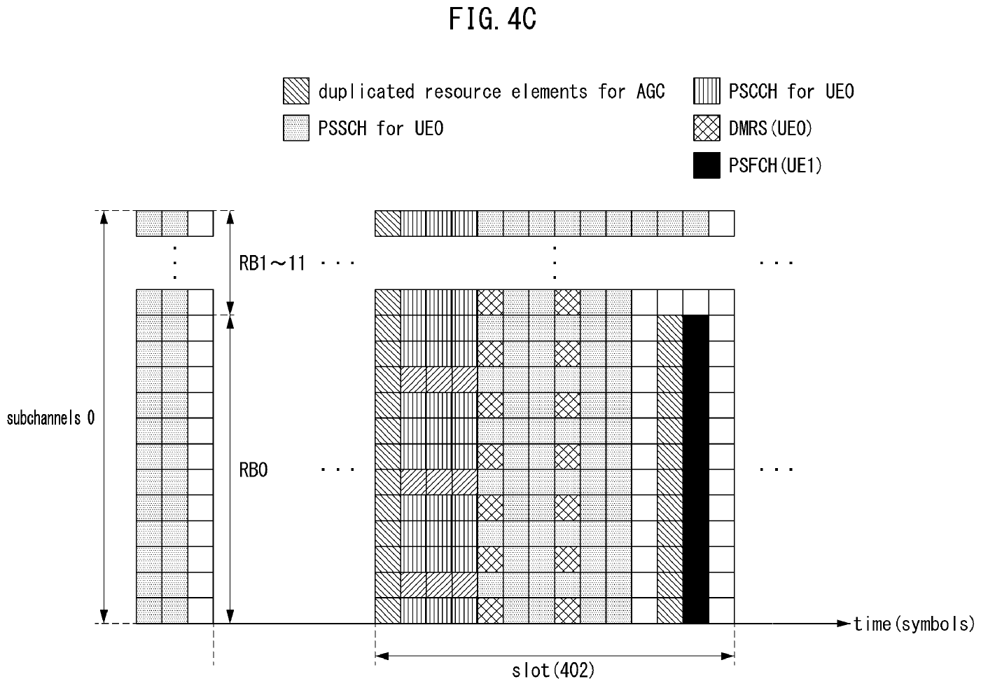

FIG. 4A is a conceptual diagram illustrating a case where 11 subchannels constitute a bandwidth part in sidelink, FIG. 4B is a conceptual diagram illustrating a partial configuration of consecutive slots in one sidelink subchannel, and FIG. 4C is a conceptual diagram illustrating the remaining configuration of the consecutive slots in the one sidelink subchannel.

Referring to FIG. 4A, a case in which up to 11 subchannels are allocated to a sidelink bandwidth part (BWP) for PSSCH transmission is illustrated. More specifically, a case in which a total of 11 subchannels from subchannel 0 410 to subchannel 10 420 are used for PSSCH transmission is illustrated. In FIG. 4A, the first symbol may comprise duplicated resource elements for automatic gain control (AGC), and the duplicated resource elements may be obtained by duplicating resource elements of a physical sidelink control channel (PSCCH), a physical sidelink shared channel (PSSCH), and/or a physical sidelink feedback channel (PSFCH).

Referring to FIG. 4B, a configuration example of the subchannel 0 410 is illustrated. A slot 401 may refer to the first slot in the subchannel 0 401 of the sidelink BWP in FIG. 4A. The subchannel 0 410 may be composed of RB0 to RB11, as illustrated in FIG. 4B. In other words, the subchannel 0 410 may be composed of 12 RBs. Therefore, when the sidelink BWP is composed of 11 subchannels as illustrated in FIG. 4A, a total of 132 RBs may be configured as the sidelink BWP.

As illustrated in FIG. 4B, one slot may comprise a PSCCH 411 for UE0 and a PSSCH for UE0, and a demodulation reference signal (DMRS) for UE0 may be included inside the PSSCH. In addition, in the example of FIG. 4B, the PSCCH 411 is allocated to symbols 1, 2, and 3 of the subchannel 0 410.

Meanwhile, in the NR sidelink communication, 2-stage sidelink control information (SCI) may be used. The 2-stage SCI may be composed of first-stage SCI (SCI1) and second-stage SCI (SCI2). The SCI1 may be transmitted on the PSCCH 411 transmitted together with the PSSCH, and the SCI2 may be transmitted on the PSSCH as being multiplexed with a transport block (TB). The main purpose of introducing 2-stage SCI in the NR sidelink communication is to reduce the complexity of SCI decoding for sensing by allowing resource sensing UEs to perform channel sensing by decoding only SCI1.

FIG. 4C illustrates the remaining configuration of the consecutive slots of FIG. 4B described above, and illustrates the last slot 402. A PSFCH carrying HARQ feedback information may be transmitted within the last slot 402 of the sidelink. FIG. 4C illustrates a case where information of UE1 is transmitted through the PSFCH.

Hereinafter, sidelink transmit power control will be described.

The NR V2X supports SL transmit power control (TPC) for PSCCH, PSSCH, PSFCH, and sidelink-synchronization signal block (S-SSB) transmission. However, since the current NR SL does not support TPC commands, only the open-loop-based SL TPC scheme is supported. The 3GPP Rel-16 NR SL specifications support TPC for unicast and groupcast transmission, and PSSCH TPC for unicast transmission largely supports the following three schemes.
SL Unicast TPC#1: Scheme using only a DL path loss PL_{DL} (i.e., path loss between a base station (gNB) and a transmitting UE)
SL Unicast TPC#2: Scheme using only an SL path loss PL_{SL} (i.e., path loss between a transmitting UE and a receiving UE)
SL Unicast TPC#3: Scheme considering both a DL path loss and an SL path loss

In the above description, the path loss is denoted as ‘PL’, the subscript ‘DL’ refers to downlink (DL), and the subscript ‘SL’ refers to sidelink (SL).

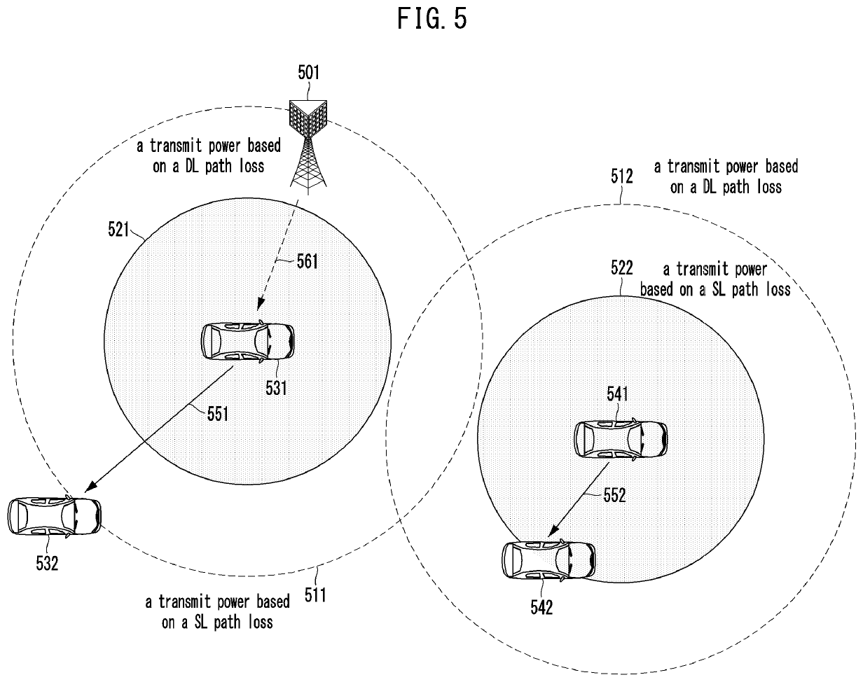

When a transmitting UE is within a network coverage and performs PSSCH TPC based on a measured DL PL, excessive interference to UL reception at the base station may be prevented. In addition, when TPC for PSSCH transmission is performed using only a DL PL, a transmitting UE located near the base station may transmit a PSSCH with a lower power than a transmitting UE located far from the base station. For example, when there is only one base station 501 in FIG. 5, a first transmitting UE 531 may be closer to the base station than a second transmitting UE 532. In this case, the first transmitting UE 531 may transmit a PSSCH with a transmit power lower than that of the second transmitting UE 532.

In addition, the DL PL-based PSSCH TPC may be activated or deactivated by the base station 501. The transmitting UE may receive a reference signal, e.g., Channel State Information-Reference Signal (CSI-RS) or a Synchronization Signal Block (SSB), transmitted by the base station 501, and the transmitting UE may obtain the DL PL by measuring a Reference Signals Received Power (RSRP) of the received reference signal.

In addition, TPC for unicast PSSCH transmission may compensate for attenuation of an SL channel through SL unicast TPC#2, which is a scheme performed based on an SL PL PL_{SL} between a transmitting UE and a receiving UE. A transmitting UE located far from the base station may perform SL transmission with an unnecessarily large transmit power if the transmit power is set through SL unicast TPC#1 (i.e., based on PL_{DL}).

Meanwhile, as illustrated in FIG. 5, if PSSCH TPC is performed considering the SL PL, the transmitting UE may be prevented from performing SL transmission with an excessively large transmit power. FIG. 5 will be described first.

FIG. 5 is a conceptual diagram illustrating an NR SL transmit power control method based on a downlink path loss and a sidelink path loss.

Referring to FIG. 5, a case in which the base station 501 and user equipments (UEs) 531, 532, 541, and 542 are deployed is illustrated. Here, the base station 501 may be understood as a gNB if it is a base station based on the 5G NR specifications, and understood as an eNB if it is a base station based on the 4G specifications. Therefore, the name referring to the base station 501 may vary depending on the supported specifications.

Each of the base station 501 and the UEs 531, 532, 541, and 542 illustrated in FIG. 5 may include all or at least some of the configurations previously described in FIG. 2. For example, the base station 501 may further include an interface for connecting to a higher node (or function) of a core network, an interface for connecting to another base station, and the like in addition to the configurations of FIG. 2. Additionally, the UEs 531, 532, 541, and 542 may further include various sensors, a communication device for communicating with satellites, a device for providing alarms to users, and the like.

In FIG. 5, the first UE 531 may receive a DL signal from the base station 501 as illustrated by a dotted arrow 561. Since the first UE 531 can receive a signal in DL, the first UE 531 may determine a transmit power based on a DL path loss. In FIG. 5, the transmit power determined by the first UE 531 based on the DL path loss may determine a range shown by reference numeral 521.

Meanwhile, a case where the first UE 531 performs SL communication with the second UE 532 is illustrated. In SL communication indicated by an arrow 551 illustrated in FIG. 5, the first UE 531 may be a transmitting (TX) UE, and the second UE 532 may be a receiving (RX) UE. Accordingly, the first UE 531 may transmit a signal to the second UE 532. Here, the first UE 531 may determine a transmit power based on an SL path loss as determining a range shown by reference numeral 511.

The third UE 541 illustrated in FIG. 5 may perform SL communication with an adjacent fourth UE 542 as illustrated by an arrow 552. As described above, in SL communication, the third UE 541 may be a transmitting UE, and the fourth UE 542 may be a receiving UE. Accordingly, the third UE 541 may transmit a signal to the fourth UE 542. Here, the third UE 541 may determine a transmit power based on an SL path loss as indicated by reference numeral 552. In addition, when the third UE 541 receives a signal from the base station, the third UE 541 may determine a transmit power based on a DL path loss as indicated by reference numeral 512.

Based on the description of FIG. 5, the SL PL-based PSSCH TPC may be applied when the transmitting UE (e.g., first UE 531 and/or third UE 541) is within or out of a network coverage. The SL PL-based PSSCH TPC may be activated or deactivated through (pre)configuration. In order to perform the SL PL-based PSSCH TPC, the transmitting UE may require an estimate of an SL PL, which can be obtained from a feedback from the receiving UE (e.g., the second UE 532 and/or the fourth UE 542).

The receiving UE may receive a reference signal (e.g., DMRS included in a PSSCH) transmitted by the transmitting UE. In addition, the receiving UE may obtain an average RSRP by repeatedly performing RSRP measurement on the reference signal a predetermined number of times. However, since the receiving UE does not know a transmit power of the reference signal, it cannot calculate an SL PL using the measured average RSRP. Instead, the receiving UE may feedback the measured average RSRP to the transmitting UE through higher-layer signaling. The transmitting UE receiving the average RSRP fed back by the receiving UE may derive the SL PL using an average transmit power of the reference signal and the average RSRP value received from the receiving UE. When the SL PL derived by the transmitting UE is denoted as PL_{SL}, PL_{SL} may be calculated as in Equation 1 below.

PL_{SL}=average transmit power of reference signal(dBm)−average RSRP(dBm) [Equation 1]

In Equation 1, the average RSRP may be the value fed back from the receiving UE to the transmitting UE.

When the transmitting UE is configured to perform PSSCH TPC using both the DL PL and the SL PL, the transmitting UE may determine a transmit power of a PSSCH as shown in Equation 2 below.

$${P}_{PSSCH , 1} = min ( \begin{matrix}{P}_{MAX} , \\ \begin{matrix}{P}_{0 , DL} + 10 {log}_{10} ( {2}^{μ} {M}_{PSSCH} ) + \\ {α}_{DL} {PL}_{DL} ,\end{matrix} \\ \begin{matrix}{P}_{0 , SL} + 10 {log}_{10} ( {2}^{μ} {M}_{PSSCH} ) + \\ {α}_{SL} {PL}_{SL}\end{matrix}\end{matrix} ) [ dBm ] \qquad [ Equation 2 ]$$

In Equation 2, TPC parameters, for example, a nominal power P₀ and a parameter a used for fractional power control, may be set separately (in advance). μ may be a value indicating a configured numerology, and M_{PSSCH} indicates the number of physical resource blocks (PRBs) of the PSSCH in a symbol without the PSCCH. M_{PSSCH} may be calculated as shown in Equation 3 below.

M_{PSSCH}=L_{subCH}·M_{sub} [Equation 3]

In Equation 3, L_{subCH} is the number of PSSCH subchannels, and M_{sub} is the number of PRBs per subchannel.

When the SL TPC is configured to be performed without considering the DL PL or SL PL, the transmitting UE may calculate the transmit power by excluding, from the arguments, the terms in the second and third lines that calculate the minimum value (min) in Equation 2. The SL PL-based PSSCH TPC is currently supported only for unicast transmission.

In addition, when both the DL PL and the SL PL are deactivated, the transmit power for the PSSCH may be determined to be the same value as P_{MAX}, a (pre)set maximum transmit power, according to the TPC calculation formula in Equation 2.

Hereinafter, 5G NR sidelink communication in an unlicensed band will be described.

The NR-Unlicensed (NR-U) is an operating mode introduced in release 16 (Rel-16) to support 5G NR networks operating in unlicensed bands. The NR-U enables UL and DL communications in unlicensed bands by supporting a variety of new functions. UL and DL communications in a frame structure type 3 newly introduced in the 5G NR-U use separate time resources within the same frequency band, similarly to the LTE time division duplex (TDD) scheme. For DL and UL communications in NR-U, resources are allocated through a channel access scheme based on Listen-Before-Talk (LBT). A terminal and a base station should check whether there is no ongoing communication in a communication channel before transmitting a signal by sensing the communication channel through an LBT technique.

According to the current 3GPP Rel-16 NR-U specifications, a unit of resources on which channel sensing is performed is an RB set. In channel sensing, if an energy level measured for each RB set is below an energy detection (ED) threshold (e.g., ED threshold of NR-U LBT considered in 3GPP TR 38.889=−72 dBm), the UE may determine that the corresponding RB set is in an idle state. Accordingly, the UE may use idle RBs for resource allocation.

The size of RB set may correspond to 100 to 110 RBs in the case of 15 kHz subcarrier spacing (SCS) and 56 RBs in the case of 30 kHz SCS. In the case of 30 kHz SCS, RB sets may each have 50 to 55 RBs, excluding at most one RB set. A guard band may exist between two adjacent RB sets. When the terminal uses two adjacent RB sets, the terminal may transmit a UL channel/signal in resources belonging to the guard band for consecutive UL resource allocation in the frequency domain. The L BT schemes supported by NR-U may be classified into types as follows.

(1) LBT Type 1 (LBT category: CAT4-LBT): The LBT procedure may be performed according to a protocol having the same processes as CSMA/CA. That is, the LBT procedure may be performed based on additional sensing slots, random back-off, and variable contention window size.

(2) LBT Type 2A (LBT category: CAT2-LBT): If a channel is determined to be idle by performing channel sensing for 251.ts, resources are allocated to the channel.

(3) LBT Type 2B (LBT category: CAT2-LBT): If a channel is determined to be idle by performing channel sensing for 161.ts, resources are allocated to the channel.

(4) LBT Type 2C (LBT category: CAT1-LBT): Resources may be allocated to a channel immediately without performing an LBT procedure. However, a channel occupancy time (COT) may be configured up to 584 μs.

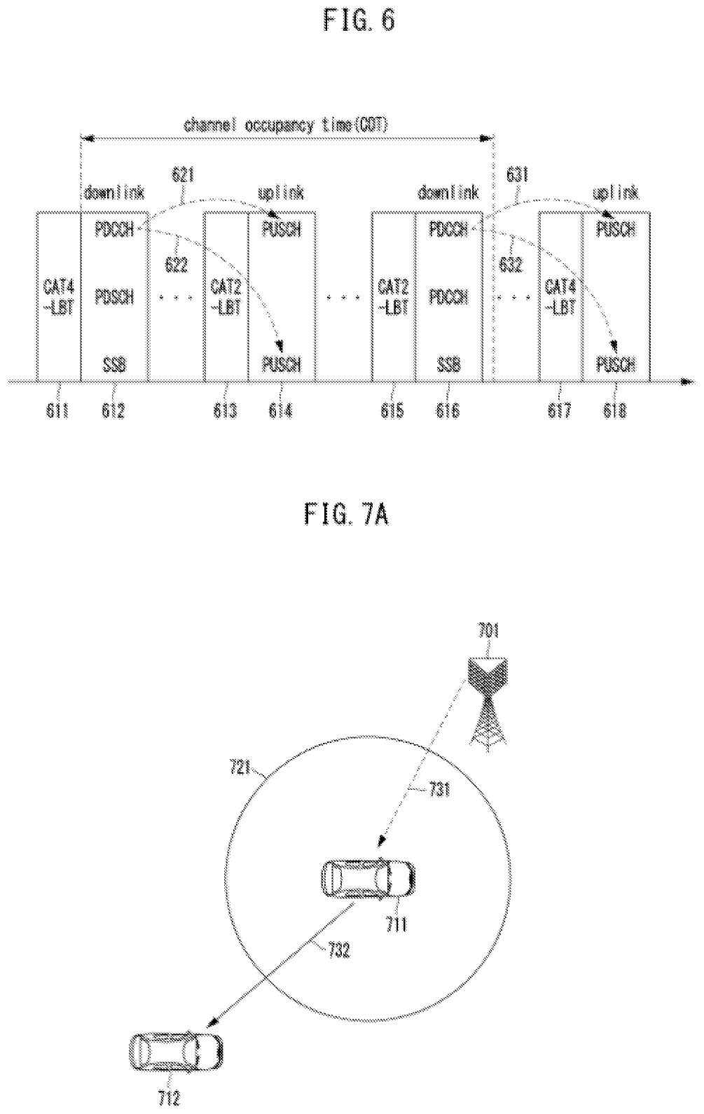

FIG. 6 is a conceptual diagram illustrating LBT-based downlink and uplink communications.

Referring to FIG. 6, a reference numeral 611 illustrates an operation in which a UE senses resources based on LBT Type 1, that is, CAT4-LBT. If a resource sensed based on the CAT4-LBT scheme 611 is determined to be idle, the AP and UE may transmit and receive control information and/or data in downlink 612. The control information may be transmitted on a physical downlink control channel (PDCCH), and the data may be transmitted on a physical downlink shared channel (PDSCH). In addition, synchronization signal blocks (SSBs) may be transmitted in the downlink 612.

Meanwhile, the PDCCHs may indicate uplink resource allocations 621, 622, 631, and 632. Uplink data may be transmitted on physical uplink shared channels (PUSCHs) in the uplink (i.e., 614 and 618) according to the indicated uplink resource allocations.

In the example of FIG. 6, a case in which the downlink communication (i.e., 612 and 616) and the uplink communication (i.e., 614 and 618) are alternately performed within a COT is illustrated. Further, CAT4-LBT procedures 611 and 617 may be performed before the COT, and CAT2-LBT procedures 613 and 615 may be performed within the COT.

Hereinafter, exemplary embodiments according to the present disclosure will be described. In the present disclosure described below, ‘configuration’ may include both configuration or pre-configuration.

### First Exemplary Embodiment: Beam-Based SL TPC Method

In order to support beam-based PSCCH/PSSCH transmission similarly to the 3GPP NR Rel-15 method in which TPC for PUSCH/physical uplink control channel (PUCCH) transmission supports beamforming, the existing SL TPC method needs to be extended. According to the 3GPP NR Rel-15 specifications, a UE may determine an initial transmit power for transmitting a PUSCH or PUCCH using a specific beam based on a DL PL measured using the specific beam.

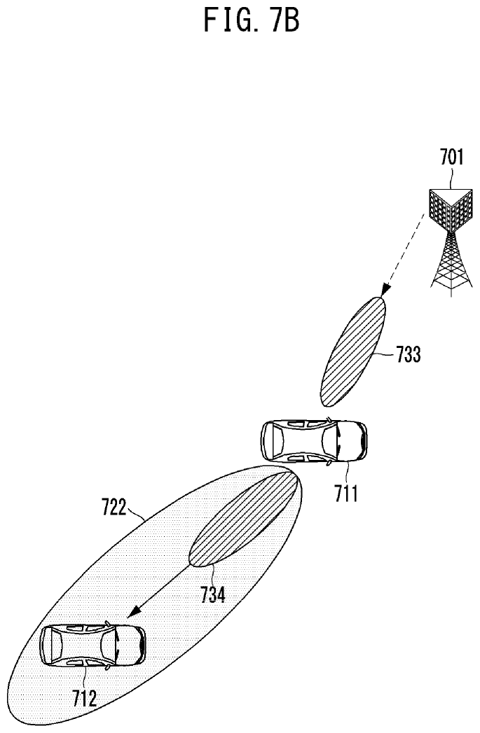

Similarly, the SL TPC method defined in the current 3GPP NR Rel-16 SL specifications may be extended to a beam-based TPC method. When a transmitting UE located within a network coverage performs DL PL-based TPC for PSCCH/PSSCH transmission, it is important to measure a DL PL for a beam through which SL transmission is to be actually performed. This will be described with reference to FIGS. 7A and 7B.

FIG. 7A is a conceptual diagram illustrating a case of DL signal reception and SL signal transmission at a UE when not using a beam, and FIG. 7B is a conceptual diagram illustrating a case of DL signal reception and SL signal transmission at a UE when using a beam.

Referring to FIG. 7A, a base station 701 and UEs 711 and 712 are illustrated. The base station 701 and the UEs 711 and 712 may include all or at least some of the configurations previously described in FIG. 2. For example, the base station 701 may further include an interface for connecting to a higher node (or function) of a core network, an interface for connecting to another base station, and the like in addition to the configurations of FIG. 2. In addition, the UEs 711 and 7112 may further include various sensors, a communication device for communicating with satellites, a device for providing alarms to users, and the like.

The first UE 711 may receive a DL signal from the base station 701, as indicated by a dotted arrow 731. In addition, the first UE 711 may transmit an SL signal to the second UE 712, as indicated by a solid arrow 732. Accordingly, the first UE 711 may be a transmitting UE, and the second UE 712 may be a receiving UE. In FIG. 7A, the SL signal transmitted by the first UE 711 may be transmitted within a range indicated by reference numeral 721. According to the example of FIG. 7A, the second UE 712 may be located in a region where it cannot receive signals transmitted by the first UE 711. In this case, the first UE 711 may need to perform TPC.

Referring to FIG. 7B, the base station 701 and UEs 711 and 712 are illustrated as previously described in FIG. 7A. It should be noted that the base station 701 and the UEs 711 and 712 may have the same configurations as described in FIG. 7A.

The first UE 711 may receive a DL signal from the base station 701 through a DL beam 733 formed in a direction indicated by a dotted arrow. Additionally, the first UE 711 may transmit an SL signal to the second UE 712 through an SL beam 734 formed in a direction indicated by a solid arrow. According to the above assumption, the first UE 711 may be a transmitting UE, and the second UE 712 may be a receiving UE.

In the following description, for convenience of description, the DL beam formed from the base station 701 to the first UE 711 will be referred to as ‘beam X’, and the SL beam formed from the first UE 711 to the second UE 712 will be referred to as ‘beam Y’.

According to the example of FIG. 7B compared to FIG. 7A, since the first UE 711 transmits the SL signal by forming the beam Y in a specific direction, for example, in the direction of the second UE 712, the signal transmitted by the first UE 711 may be transmitted within a range indicated by reference numeral 722. Therefore, according to the example of FIG. 7B, the second UE 712 may receive the SL signal transmitted by the first UE 711.

Comparing FIGS. 7A and 7B, even when a distance between the first UE 711 and the second UE 712 is the same, a reach distance of the SL signal and a range over which the signal propagates may vary depending on whether a beam is used. In other words, in the case of FIG. 7A, it can be seen that the range 721 where the SL signal transmitted by the first UE 711 reaches is a certain radius from the first UE 711. On the other hand, in the case of FIG. 7B, it can be seen that the range 722 where the SL signal transmitted by the first UE 711 reaches is elliptical, which is the direction of the second UE 712.

In FIG. 7A, a case is illustrated where the base station 701 does not form a beam. However, as illustrated in FIG. 7B, the base station 701 may form a beam for transmission of a DL signal, and the first UE 711 may transmit a signal to the second UE 712 without forming a beam.

As another example, as illustrated in FIG. 7A, the base station 701 may not transmit a DL signal by forming a beam for transmission of the DL signal, and the first UE 711 may form a beam to transmit an SL signal to the second UE 712.

Based on what has been described above, situations that need to be kept in mind when performing PL-based transmit power determination will be described.

In the case of FIG. 7B, the first UE 711 may receive a DL signal from the base station 701 using the beam X. Therefore, the first UE 711 may receive the strongest DL signal through the beam X. In other words, a case of measuring a signal strength using the beam X received from the base station 701 may correspond to a case of obtaining a minimum DL PL.

When the first UE 711 wishes to perform PSCCH/PSSCH transmission to the second UE 712, the first UE 711 needs to determine a transmit power of the beam Y. In this case, the first UE 711 may know the minimum DL PL based on the strongest DL signal through the beam X. However, when determining the transmit power of the beam Y, the first UE 711 should not determine the transmit power of the beam Y based on the minimum DL PL measured on the beam X.

As described above, the SL transmission of the first UE 711 may interfere with the UL reception at the base station 701. Therefore, the first UE 711 needs to determine the transmit power of the SL signal to be transmitted to the second UE 712 based on the measured DL PL. In this case, the DL PL should be a value measured using a beam to be used for SL transmission, not the beam used in DL communication.

Therefore, the present disclosure proposes a procedure for DL PL measurement and SL TPC using it as follows.

### (1) TPC Method for Beam-Based Unicast Transmission

First, when performing TPC for unicast transmission in consideration of a DL PL, the transmitting UE (e.g., first UE 711) may receive a DL reference signal using an SL beam \hat{b}.

A. As for the definition of SL beam \hat{b} for DL PL measurement, at least one of i) to iv) below may be applied.

i) A beam candidate group comprising one or more beams to be used for SL transmission. That is, s\hat{b}=B_{unicast}.

In this case, the DL RSRP may be measured by simultaneously using all beams in B_{unicast}, or the DL RSRP may be measured by alternating the beams in B_{unicast}.

ii) A beam arbitrarily selected from the beam candidate group B_{unicast}. That is, \hat{b}∈B_{unicast}.

iii) A beam used in recent transmission. That is, \hat{b}=bₚᵣₑᵥ.

iv) A beam to be used for SL transmission. That is, \hat{b}=b (here, b indicates the beam to be used for SL transmission).

B. The UE may receive a DL reference signal using the SL beam \hat{b} and measures the RSRP. As the RSRP measurement scheme for deriving PL_{DL,\hat{b}}, one among i) to iii) below may be selected.

i) Calculate an average RSRP of the beam \hat{b} within a designated (or configured) measurement window

ii) Calculate the maximum RSRP of the beam \hat{b} within a designated (or configured) measurement window

iii) Calculate the minimum RSRP of the beam \hat{b} within a designated (or configured) measurement window

The designated measurement window or configured measurement window of i) to iii) above may be designated or configured in advance.

Second, the transmitting UE may calculate the transmit power for the SL transmission beam b using Equation 4 below.

$$\begin{matrix}{P}_{PSSCH , b} = min ( {P}_{MAX} , {P}_{MAX \_ DL , b , \hat{b}} , {P}_{MAX \_SL , b} ) \\ = min ( \begin{matrix}{P}_{MAX} , \\ \begin{matrix}{P}_{0 , DL} + 10 {log}_{10} ( {2}^{μ} {M}_{PSSCH , b} ) + \\ {α}_{DL , \hat{b}} {PL}_{DL , \hat{b}} ,\end{matrix} \\ \begin{matrix}{P}_{0 , SL} + 10 {log}_{10} ( {2}^{μ} {M}_{PSSCH , b} ) + \\ {α}_{SL , b} {PL}_{SL , b}\end{matrix}\end{matrix} ) [ dBm ]\end{matrix} \qquad [ Equation 4 ]$$

In Equation 4, P_{MAX} is the maximum transmit power that the transmitting UE can use, P_{MAX_DL,b,\hat{b}} is the transmit power of the sidelink beam \hat{b} calculated using the DL path loss measured by the sidelink beam \hat{b}, and P_{MAX_SL,b} is the transmit power of the sidelink beam b calculated using the SL path loss measured by the sidelink beam b. In addition, α_{DL,\hat{b}} and α_{SL,b} are separately (pre)defined values, and PL_{DL,\hat{b}} is the path loss value measured by receiving the DL reference signal using the beam \hat{b}. P_{0,DL} or P_{0,SL} is a pre-configured value used in fractional power control, and may generally refer to a target receive power of DL or SL communication. M_{PSSCH,b} may indicate the number of PRBs used for PSSCH transmission. In addition, PL_{SL,b} is an SL path loss value to be used for SL communication through the SL transmission beam b. Measurement of PL_{SL,b} may be performed using the beam \hat{b} in the same manner as the DL path loss measurement.

Third, although configured to consider the DL PL, if an RSRP for the DL reference signal cannot be measured using the beam \hat{b} or sufficient measurements are not performed within the specified measurement window, one value below may be applied as PL_{DL,\hat{b}}.

A. (Pre)configured DL PL value PL_{DL,pre-config}

B. Most recently applied DL PL value PL_{DL,prev}

Fourth, the base station may activate or deactivate a mode allowing the SL transmitting terminal to calculate the transmit power by excluding P_{MAX_DL,b,\hat{b}} from Equation 4 above through higher layer signaling (or DCI, MAC CE). The SL transmitting UE with this mode activated may perform one of the two operations below. One of the two operations below may be performed based on additional indication from the base station.

A. Operation 1: The transmit power is always calculated by excluding P_{MAX DL,b,\hat{b}} from the calculation formula.

B. Operation 2: The transmit power is calculated by excluding P_{MAX_DL,b,\hat{b}} from the calculation formula only when one of the conditions below is satisfied.
Condition 1: When it is determined that an angle difference between the directions of the SL beam \hat{b} and a DL/UL beam b′ is equal to or greater than a (pre)set angle value: |θ_{\hat{b}}−θ_{b′}|≥θₜₕ
Condition 2: When the SL beam \hat{b} and the DL/UL beam b′ belong to different beam groups
Condition 3: When the DL RSRP measured by the SL beam \hat{b} is greater by a (pre)set value or more than the RSRP value measured by the DL/UL beam b′: |RSRP_{\hat{b}}−RSRP_{b′}|≥RSRPₜₕ

It should be noted that the first exemplary embodiment described above may be used in combination with other exemplary embodiments, the second exemplary embodiment and the third exemplary embodiment, which will be described below.

### Second Exemplary Embodiment: Method for Supporting Consecutive Slots in SL-U

At the 3GPP RAN1#109-e meeting, it was agreed to support slot-based PSCCH/PSSCH transmission of at least the existing Rel-16/17 NR SL for NR SL-U. In addition, the 3GPP RAN1#109-e meeting discusses whether to support additional staring symbol positions within a slot for PSCCH and PSSCH transmission. Then, the position of the additional starting symbol will be discussed below with reference to the accompanying drawing.

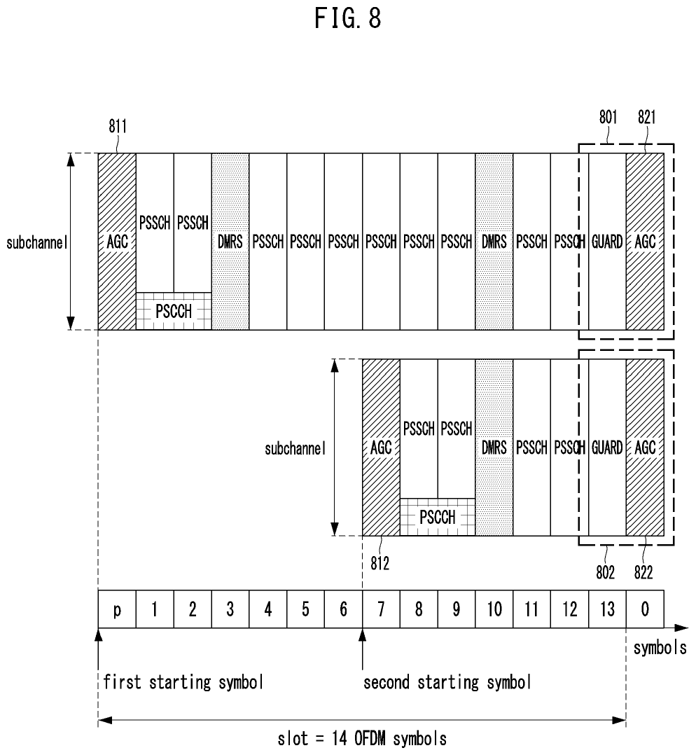

FIG. 8 is a conceptual diagram illustrating starting symbol positions in the SL-U time domain.

Referring to a lower part of FIG. 8, a case in which 14 OFDM symbols constitute one slot is illustrated. In general, in SL-U communication, an ACG symbol may be transmitted as a symbol 0, as shown by reference numeral 811. In addition, a PSCCH may be transmitted in a part of symbols 1 and 2, and a PSSCH may be transmitted in the remaining part of the symbols 1 and 2. A DMRS may be transmitted in symbols 3 and 10, and a PSSCH may be transmitted in symbols 4 to 9, and symbols 11 and 12. A symbol 13 may correspond to a guard time. In other words, all symbols within the slot may be transmitted as symbols for SL-U communication.

Meanwhile, in FIG. 8, a time at which symbols for SL-U communication are transmitted may be determined to start from a position corresponding to (1/2) of the slot, as indicated by reference numeral 812. The time corresponding to (1/2) of the slot shown in FIG. 8 is merely an example and is not limited thereto. The advantage of introducing additional starting symbol(s), as shown in FIG. 8, is that a COT loss may be reduced by increasing an opportunity for an SL-U UE to access an unlicensed band channels with a higher probability.

Meanwhile, at the 3GPP RAN1#110 meeting, it was agreed to additionally support multi-consecutive slot transmission (MCSt). When performing MCSt, there is an advantage of improving resource efficiency by utilizing a guard symbol between adjacent slots and an AGC symbol starting first in a consecutive slot for SL transmission (e.g. PSSCH transmission). These two symbols will be referred to as flexible symbols in the present disclosure.

When performing MCSt, LBT procedures of other UEs may be affected due to the use of flexible symbols used in MCSt. Therefore, it is necessary to define allocation conditions for flexible symbols for SL transmission. Since symbols 801 and/or 802 in FIG. 8 correspond to the flexible symbols, a UE capable of using such the flexible symbols when performing MCSt may continuously transmit one or more TBs using the corresponding symbols.

Hereinafter, a case where an LBT procedure succeeds in a first starting symbol and a TB is transmitted continuously, and a case where an LBT procedure succeeds in a second starting symbol and a TB is transmitted will be described with reference to FIG. 8.

It is assumed that the position of the second starting symbol is located at the position of the eighth symbol in FIG. 8. However, the position of the second starting symbol may not be located at the position of the eighth symbol as described above. The position of the second starting symbol may be located later in the slot than illustrated in FIG. 8. For example, the position of the second starting symbol may be in the rear portion of the slot, such as the tenth symbol or the twelfth symbol. As another example, the position of the second starting symbol may be located in the front portion of the slot than illustrated in FIG. 8. For example, it may be located ahead of the case illustrated in FIG. 8, such as the fifth symbol (symbol 4) or the sixth symbol (symbol 5).

As the position of the second starting symbol is located later in the slot, a problem of insufficient resources may occur compared to the case of transmitting the TB by scheduling based on the first slot (slot 0). Accordingly, the present disclosure proposes the following in this regard.

(1) The UE may continuously transmit one or a plurality of TBs by performing MCSt.

In other words, the UE may determine the number of TBs to transmit by performing MCSt. First, determination of whether to perform MCSt may be made based whether to perform an LBT procedure. In addition, the number of TBs may be determined based on the size of resources acquired for performing MCSt and the size of TBs to be transmitted. Other factors may also be considered. Since it is not possible to list all the various factors that determine the number of TBs when performing MCSt, further description will be omitted.

(2) The UE may have a threshold priority value prio th for determining whether flexible symbols are allocatable for transmission of SL signals (e.g., PSSCH transmission and/or PSFCH transmission). The threshold priority value may be set by a higher layer. The UE may utilize flexible symbols for SL transmission if a priority value of a packet the UE wishes to transmit is higher than or equal to the threshold priority value.

A. For example, if prio_{TX}, which is the priority value of the packet (i.e., TB) to be transmitted, is lower than or equal to the threshold priority value prioth, the UE may use flexible symbols for PSSCH transmission. Here, the lower the priority value, the higher the priority.

(3) When the UE recognizes that a neighboring UE wishes to transmit a packet with a higher priority than the packet itself wishes to transmit, the UE may not allocate flexible symbols for any purpose other than the basic purpose (i.e., Guard or AGC).

In other words, the transmitting UE may receive a packet transmitted by another neighboring (or nearby) UE and inspect (or identify) a priority of the received packet. Based on the inspection (or identification), the transmitting UE may compare the priorities of the SL data itself wishes to transmit and the packet transmitted by another neighboring (or nearby) UE. Based on a result of comparing the priorities, the transmitting UE may or may not use flexible symbols for TB transmission. For example, if the priority of the packet transmitted by another neighboring (or nearby) UE is higher than the priority of the SL data to be transmitted by the transmitting UE, the transmitting UE may configure the flexible symbols not to be used for SL data transmission. On the other hand, if the priority of the packet transmitted by another neighboring (or nearby) UE is lower than or equal to the priority of the SL data to be transmitted by the transmitting U, the transmitting UE may configure the flexible symbols to be used for SL data transmission.

(4) A reference position of the second starting symbol may be preconfigured by the higher layer, and the UE may know the reference position of the second starting symbol preconfigured by the higher layer.

(5) When transmission is determined in a symbol after or at the reference position of the second starting symbol and MCSt is performed, the UE may transmit one TB in consecutive slots. In this case, the size of the TB (TBS) may be determined using one of the two methods below.

A. The TBS may be determined as a TBS pre-calculated assuming that an LBT procedure succeeds in a symbol 0 and the TB is transmitted within one slot.

B. A TBS recalculated based on the total number of symbols for MCSt may be applied. Here, the number of symbols may or may not include the number of flexible symbols.

Whether flexible symbols are included will be described by taking an example. When both or at least one of two adjacent flexible symbols is allocated to PSSCH transmission, the one or two flexible symbols may be included in the TBS calculation. If both adjacent flexible symbols are not allocated to PSSCH transmission, the flexible symbols may be excluded in the TBS calculation.

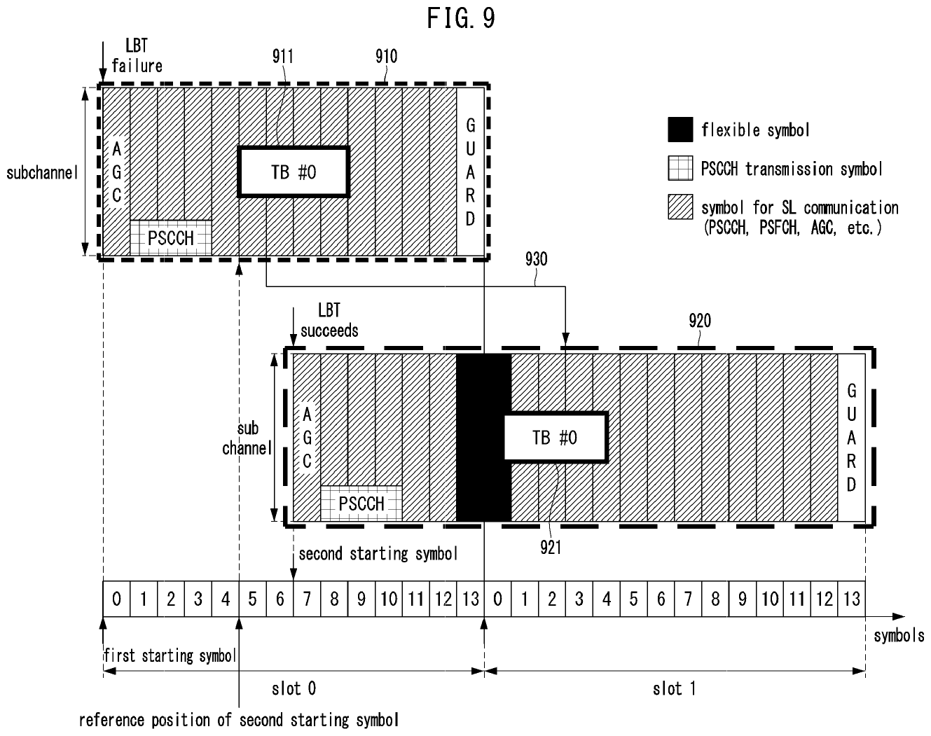

The contents of (4) and (5) will be described in further detail with reference to FIG. 9.

FIG. 9 is a conceptual diagram illustrating a case in which one TB is transmitted when MCSt is performed in the time domain of NR SL-U.

Referring to FIG. 9, two consecutive slots (i.e., slot 0 and slot 1) are illustrated, and each slot is composed of 14 OFDM symbols as previously described in FIG. 8.

First, the first starting symbol may be located at a symbol 0 of a slot 0. A reference position for the second starting symbol may be preconfigured by the higher layer as a symbol 5 of the slot 0, which is the sixth symbol. In addition, as shown by reference numeral 910, SL data may be transmitted in most symbols of the symbol 0. However, according to the reference numeral 910, SL data transmission may not be performed in an AGC symbol, some RBs of symbols 1 to 3 in which PSCCH is transmitted, and a guard symbol of the slot 0.

When a transmitting UE wishes to transmit a TB #0 911 in the slot 0, a case when an LBT procedure fails in the symbol 0 of the slot 0 and an LBT procedure succeeds in the first starting symbol of the slot 0, or a case when the transmitting UE wishes to transmit the TB #0 911 at the reference position of the second starting symbol may be considered. In other words, the illustration assumes that the transmitting UE attempts to transmit the TB #0 911 at a position of the symbol 5 of the slot 0.

However, an LBT procedure may actually succeed at the position of the symbol 7 of the slot 0, which is after the position of the second starting symbol. That is, FIG. 9 illustrates a case when the LBT procedure succeeds in a symbol after the reference position of the second starting symbol. Accordingly, the transmitting UE may be in a state of being unable to transmit the TB #0 911 at the reference position for the second starting symbol, which is the desired position.

As illustrated in FIG. 9, if the LBT procedure succeeds in the symbol 7 of the slot 0, which is after the reference position of the second starting symbol, the UE may be able to transmit SL data in the symbol 7 of the slot 0. Also, since the case of FIG. 9 corresponds to a case where MCSt is performed, SL data may be transmitted continuously up to the slot 1. As described above, the SL data may be transmitted from the time of the slot 0, at which the LBT procedure succeeds, to the slot 1, and this is illustrated by reference numeral 920 in FIG. 9.

Since the TB #0 that the UE wishes to transmit cannot be transmitted in the slot 0 as described above, the SL data may be transmitted in a transmittable symbol region as indicated by reference numeral 920. Therefore, the SL data may be transmitted in some symbols of the slot 1, like the TB #0 921.

In this case, when performing MCSt as described in (5), the UE may transmit one TB, that is, the TB #0 921, in consecutive slots. In the example of FIG. 9, a case where the TB #0 921 is transmitted at the position of the flexible symbol in the slot 1 is illustrated. As illustrated in FIG. 9, transmission of the TB #0 921 may start in the middle of the flexible symbol, or may start at the start position of the flexible symbol. As another example, transmission of the TB #0 (921) may start at a position excluding the flexible symbol, that is, the symbol 1 of the slot 1.

In addition, the TBS may be determined as a TBS calculated assuming that the TB is transmitted after the LBT procedure succeeds in the symbol 0 of the slot 0. This is because the TBS of TB #0 921 that is actually transmitted may be the same as the TBS when the TB #0 911 is transmitted by the LBT procedure succeeding in the symbol 0 of the slot 0, as illustrated by reference numeral 930.

As another example, a TBS recalculated based on the total number of symbols required for MCSt may be applied. In this case, the total number of symbols may be calculated considering the case where transmission of the TB #0 921 is started from a middle of the symbol 0, which is a flexible symbol of the slot 1, as illustrated in FIG. 9. In this case, the total number of symbols for the TB #0 921 may be different from the TB #0 911. In other words, the TB #0 921 transmitted in the slot 1 may be transmitted in a period corresponding to a total of 5 symbols from the symbol 0 to the symbol 4. On the other hand, the TB #0 911 may be transmitted in a period corresponding to a total of 4 symbols from symbol 5 to symbol 8 of the slot 0. As described, the total number of symbols may vary depending on the transmission position of the TB.

(6) When the second starting symbol is determined to be a symbol before the reference position for the second starting symbol (excluding a symbol at the reference position) and MCSt is performed, the UE may transmit different TBs in consecutive slots. In this case, a TBS may be determined using one of the two methods below.

A. The TBS of the TB #0 may be determined as a TBS pre-calculated assuming that an LBT succeeds at a symbol 0 and the TB is transmitted within one slot.

B. The TBS of the TB#0 may be recalculated considering the shortened length of symbols. Here, the number of symbols may or may not include the number of flexible symbols. For example, if the last flexible symbol is allocated to PSSCH transmission, it may be included in the TBS calculation. If the last flexible symbol is not allocated to PSSCH transmission, it may be excluded in the TBS calculation.

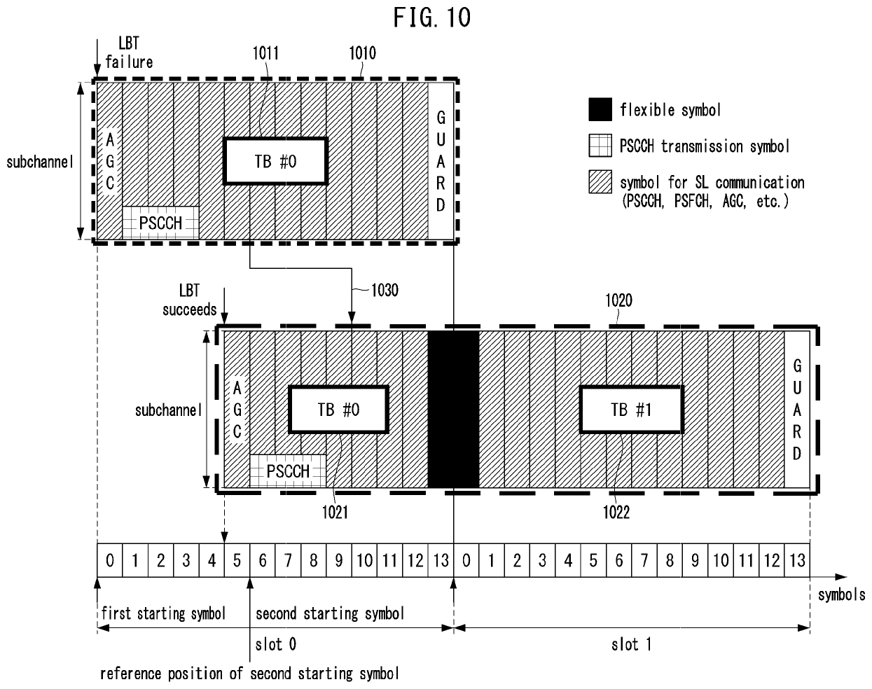

The contents of (6) will be described in further detail with reference to FIG. 10.

FIG. 10 is a conceptual diagram illustrating a case in which two TBs are transmitted when MCSt is performed in the time domain of SL-U.

Referring to FIG. 10, two consecutive slots (slot 0 and slot 1) are illustrated, and each slot is composed of 14 OFDM symbols as previously described in FIGS. 8 and 9.

In FIG. 10, as in FIG. 9, the first starting symbol may be located in a symbol 0 of a slot 0. Unlike FIG. 9, a reference position of the second starting symbol may be a symbol 6 of the slot 0, which is the seventh symbol. The reference position of the second starting symbol may be preconfigured by the higher layer as described above. In addition, in the slot 0 comprising subchannels indicated by reference numeral 1010, SL data may be transmitted in most symbols if an LBT procedure succeeds in the symbol 0. However, even when the LBT procedure succeeds in the symbol 0 of the slot 0, SL data transmission may not be performed in an AGC symbol, some RBs of symbols 1 to 3 where a PSCCH is transmitted, and a guard symbol.

When a transmitting UE wishes to transmit a TB #0 1011 in the slot 0, the transmitting UE may wish to transmit from the symbol 5, which is one symbol before the reference position of the second starting symbol. In this case, if the LBT procedure succeeds in the symbol 5 of the slot 0, it may be transmitted as a TB #0 1021. In this case, as shown by reference numeral 1030, a TBS of the TB #0 1011 to be initially transmitted and a TBS of the TB #0 1021 that is actually transmitted may have the same value.

In addition, as described in (6), when the second starting symbol is determined to be a symbol before the reference position of the second starting symbol and MCSt is performed, different TBs may be transmitted in consecutive slots. In other words, as illustrated in FIG. 10, the TB #0 1021 may be transmitted in the slot 0, and a TB #1 1022 may be transmitted in the slot 1.

In this case, a TBS of the TB #0 1021 may be the same value as a TBS pre-calculated assuming that the LBT succeeds in the symbol 0 and the TB #0 1011 is transmitted within one slot. As another example, the TBS of TB #0 1021 may consider that the LBT does not succeed in the symbol 0 and the number of symbols used for transmission in the slot 0 decreases. Accordingly, the number of symbols for the TB #0 1021 may be recalculated. For example, as illustrated in FIG. 10, the TB #0 1021 may be transmitted in symbols from the symbol 7 to the symbol 11 of the slot 0.

FIG. 10 illustrates a case where the TB #0 1021 is not transmitted in flexible symbol(s). If the TB #0 1021 is transmitted in flexible symbol(s), the number of the flexible symbol(s) may be included in the TBS calculation.

It should be noted that the second exemplary embodiment described above may be used in combination with the first exemplary embodiment described above as well as the third exemplary embodiment described below.

### Third Exemplary Embodiment: Method for Supporting Consecutive Slots in SL-U

In SL-U, the number of available RBs in some subchannels may be less than the number of RBs in the remaining subchannels due to a guard band (GB) between adjacent resource block (RB) sets. In the third exemplary embodiment of the present disclosure, a method for solving problems caused by the guard band will be described.

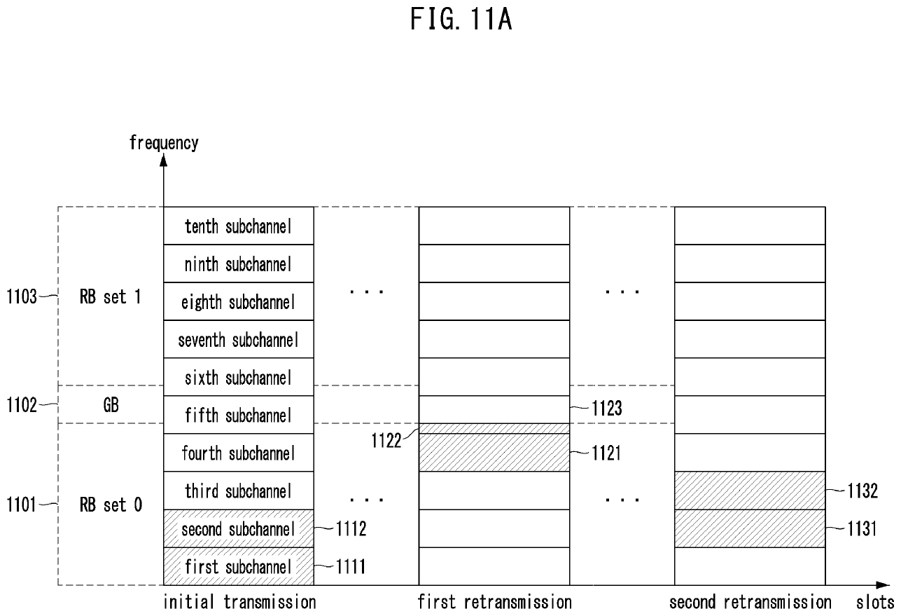

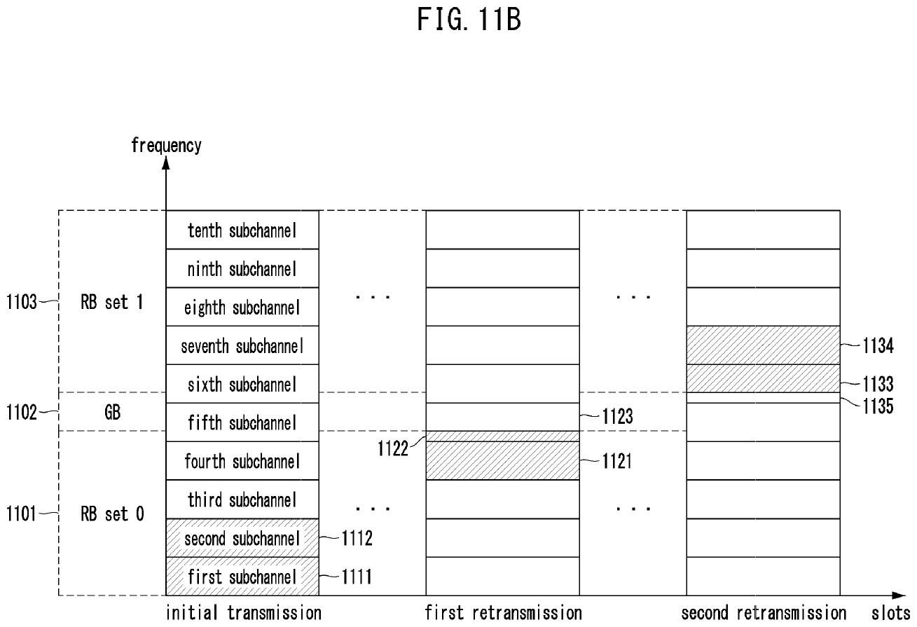

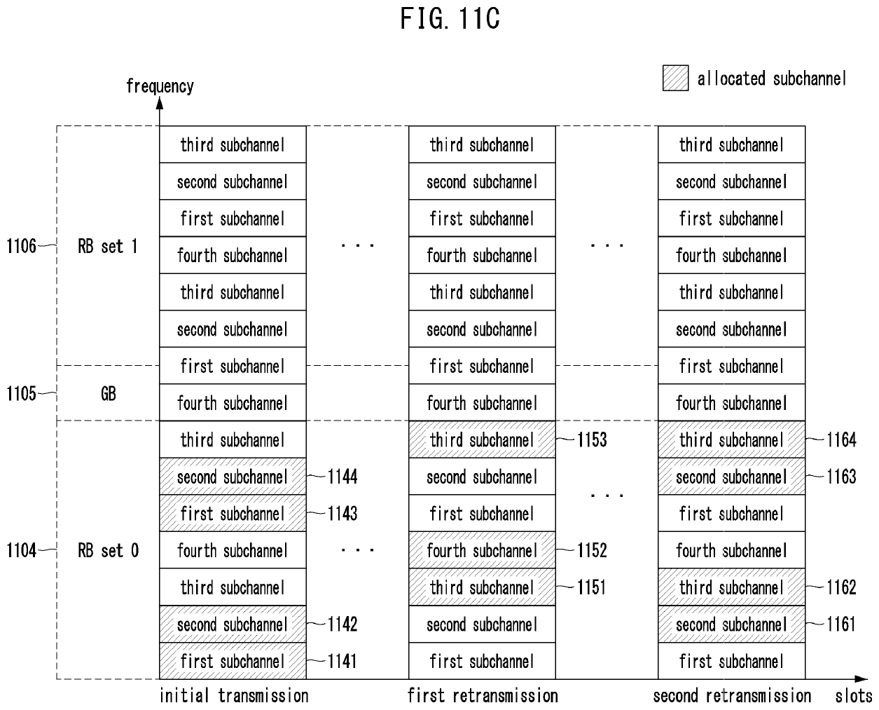

FIG. 11A is a conceptual diagram illustrating a first exemplary embodiment of resource allocation in initial transmission and retransmission of NR SL-U.

Referring to FIG. 11A, a horizontal axis illustrates slots as time units, and a vertical axis illustrates RB sets as frequency units. In addition, on the horizontal axis, subchannels at a first time, that is, the leftmost subchannels, show an example of RB resources allocated in initial transmission, second subchannels at a second time, that is, the middle subchannels, show an example of RB resources allocated in the first retransmission, and subchannels at a third time, that is, the rightmost subchannels, show an example of RB resources allocated in the second retransmission.

In FIG. 11A, the first to fourth subchannels and a portion of the fifth subchannel on the vertical axis may be one RB set illustrated as an RB set 0 1101. In addition, an RB set 1 1103 is illustrated as including a portion of the sixth subchannel and the seventh to tenth subchannels. RBs between the RB set 0 1101 and the RB set 1 1103 may be a guard band (GB) 1102.

The reason why the RB sets 1101 and 1103 are not arranged in subchannel units as illustrated in FIG. 11A is that a resource allocation unit for SL communication is a subchannel, and a resource allocation unit for 5G NR is an RB. In other words, a specific RB set may consist of complete subchannels. For example, each of the subchannels included in one RB set may be completely included in the RB set. However, since the units of RB and subchannel are different, in general, a subchannel only a portion of which is included in one RB set may exist as exemplified in FIG. 11A. In other words, the RB sets and subchannels may not match, as in the RB set 0 1101 including only some resources of the fifth subchannel.

In SL communication according to the example of FIG. 11A, the transmitting UE may transmit SL data through the first subchannel 1111 and the second subchannel 1112 of the RB set 0 1101 in initial transmission. In the first retransmission, the transmitting UE may transmit SL retransmission data (i.e., first retransmission data) using the fourth subchannel 1120 and only some resources of the fifth subchannel 1101, which are included in the RB set 0 1101. In the second retransmission, the transmitting UE may transmit SL retransmission data (i.e., second retransmission data) through the second subchannel 1131 and the third subchannel 1132.

As in the example of FIG. 11A, when the GB 1102 spans the fifth and sixth subchannels, the transmitting UE may transmit SL data to the receiving UE(s) in the initial transmission, and receive a feedback of a reception failure from (at least one) receiving UE. Then, the transmitting UE may retransmit the SL data through a first retransmission resource including the fourth subchannel 1121 and some resources 1122 of the fifth subchannel, which are included in the RB set 0 1101. Here, the first retransmission resource may be a resource available through an LBT procedure after a failure of the initial transmission. In this case, it is assumed that an LBT procedure succeeds only in the RB set 0 1101. Then, a region 1123 of the fifth subchannel, which is PRB(s) belonging to the GB 1102, cannot be used. Accordingly, when compared to the initial transmission, the number of PRBs available during the first retransmission is reduced due to the region 1123 of the fifth subchannel, which is PRB(s) belonging to the GB 1102. Accordingly, the transmitting UE needs to increase an effective code rate for transmitting the SL data. As the effective code rate increases, a probability of a retransmission failure may also increase. Therefore, a second retransmission may be necessary.

As described in FIG. 11A, when one subchannel of one RB set cannot be fully used due to a mismatch between RB set and subchannel, and thus SL data is retransmitted, a probability of failure may increase, which may result in waste of resources.

FIG. 11B is a conceptual diagram illustrating a second exemplary embodiment of resource allocation in initial transmission and retransmission of NR SL-U.

Similarly to FIG. 11A, referring to FIG. 11B, a horizontal axis illustrates slots as time units, and a vertical axis illustrates RB sets as frequency units. In addition, on the horizontal axis, subchannels at a first time, that is, the leftmost subchannels, show an example of RB resources allocated during initial transmission, second sub channels at a second time, that is, the middle subchannels, show an example of RB resources allocated during the first retransmission, and subchannels at a third time, that is, the rightmost subchannels, show an example of RB resources allocated during the second retransmission.

In FIG. 11B, as in FIG. 11A, the first to fourth subchannels and a portion of the fifth subchannel on the vertical axis may be one RB set illustrated as the RB set 0 1101 having the same reference numeral as FIG. 11A. In addition, the RB set 1 1103 is also illustrated as including a portion of the sixth subchannel and the seventh to tenth subchannels as in FIG. 11A. Therefore, RBs between the RB set 0 1101 and the RB set 1 1103 may be the guard band GB 1102. In this case, as described above, it should be noted that the RB sets 1101 and 1103 are not arranged on a subchannel basis.

In SL communication according to the example of FIG. 11B, the transmitting UE may transmit SL data through the first subchannel 1111 and the second subchannel 1112 of the RB set 0 1101 in the initial transmission. In the first retransmission, the transmitting UE may transmit SL retransmission data (i.e., first retransmission data) using the fourth subchannel 1121 and only resources 1122 of the fifth subchannel, which are included in the RB set 0 1101. As described above, the SL data is transmitted through the same resources as the resources exemplified by FIG. 11A in the initial transmission and the first retransmission.

FIG. 11B illustrates a case where resources of the RB set 1 1103 are allocated in the second retransmission. In other words, in the second retransmission, the transmitting UE may perform an LBT procedure and use only resources of the RB set 1 1103. In this case, when the transmitting UE retransmits second SL data in FIG. 11B, the transmitting UE may retransmit the SL data using the seventh subchannel 1134 and a portion 1134 of the sixth subchannel, which is included in the RB set 1 1103.

In other words, in FIG. 11B, the transmitting UE may transmit the SL data using the subchannels included in the RB set 0 1101 in the initial transmission and the first retransmission, but transmit the SL data using the subchannels included in the RB set 1 1103 in the second retransmission. As previously assumed, the LBT procedures succeeds only in the RB set 0 110 in the initial transmission and first retransmission, and the LBT procedure succeeds only in the RB set 1 1103 in the second retransmission.

According to the example in FIG. 11B, it can be seen that the number of PRBs used by the transmitting UE to transmit the SL data in the initial transmission, the number of PRBs used to transmit the SL data in the first retransmission, and the number of PRBs used to transmit the SL data in the second retransmission are all different. In the initial transmission, the transmitting UE may transmit the SL data using all PRBs of the first subchannel 1111 and the second subchannel 1112. However, in the first retransmission, the transmitting UE may transmit the SL data using all PRBs in the fourth subchannel 1121 and only some PRBs 1122 of the fifth subchannel, which are included in the RB set 0 1101. In addition, in the second retransmission, the transmitting UE may transmit the SL data using the PRBs 1133 of the sixth subchannel 1133, which are included in the RB set 1 1103, and all PRBs 1134 of the seventh subchannel. That is, the PRBs 1133 of the sixth subchannel, which are included in the RB set 1 1103, can be used in the second retransmission, but the PRBs 1135 of the sixth subchannel, which are included in the GB 1102, cannot be used in the second retransmission.

Therefore, it can be seen that the number of PRBs available in the initial transmission, the number of PRBs available in the first retransmission, and the number of PRBs available in the second retransmission are all different.

As described above, because the resource allocation scheme of SL data and the resource allocation scheme of 5G NR are different from each other, there may be a problem that the number of PRBs for SL data transmission in the initial transmission and the number of PRBs for SL data transmission in the retransmission (i.e., second retransmission and third retransmission) cannot always be guaranteed to be the same. Therefore, an appropriate TBS calculation method is needed in the initial transmission and the retransmission.

FIG. 11C is a conceptual diagram illustrating a third exemplary embodiment of resource allocation in initial transmission and retransmission of NR SL-U.

FIG. 11C illustrates an interlaced RB (I-RB)-based configuration while FIGS. 11A and 11B illustrate continuous RB (CRB)-based configuration.

Referring to FIG. 11C, a horizontal axis illustrates slots as time units, and a vertical axis illustrates RB sets as frequency units. In addition, on the horizontal axis, subchannels at a first time, that is, the leftmost subchannels, show an example of RB resources allocated during initial transmission, second subchannels at a second time, that is, the middle subchannels, show an example of RB resources allocated during the first retransmission, and subchannels at a third time, that is, the rightmost subchannels, show an example of RB resources allocated during the second retransmission.

In FIG. 11C, since the subchannels are configured based on I-RBs, a structure in which the first to fourth subchannels are repeated after the first to fourth subchannels on the frequency axis may be given in initial transmission.

In FIG. 11C, the first to fourth subchannels on the vertical axis and the repeated first to third subchannels may form one RB set, which is illustrated as an RB set 0 1104. In addition, an RB set 1 1106 is illustrated as having a structure including a portion of the third repeated first subchannel, RB resources from the third repeated second to fourth subchannels, and RB resources of the fourth repeated first to third subchannels. In addition, RBs between the RB set 0 1104 and the RB set 1 1106 may be a guard band (GB) 1105.

In SL communication according to the example of FIG. 11C, the transmitting UE may transmit SL data through the first subchannel 1141, the second subchannel 1142, the repeated first subchannel 1143, and the repeated second subchannel 1144 of the RB set 0 1104 in initial transmission. In the first retransmission, the transmitting UE may transmit SL retransmission data (i.e., first retransmission data) using PRBs of the third subchannel 1151, the fourth subchannel 1152, and the repeated third subchannel 1153. In the second retransmission, the transmitting UE may transmit SL retransmission data (i.e., second retransmission data) using the second subchannel 1161, the third subchannel 1162, the repeated second subchannel 1163, and the repeated third subchannel 1164.

FIG. 11C may correspond to a case when the transmitting UE succeeds the LBT procedure only in the RB set 0 1104 and fails the LBT procedure in the RB set 1 1106 all in the initial transmission, first retransmission, and second retransmission. Therefore, the transmitting UE may transmit the SL data using only the RB set 0 1104.

As illustrated in FIG. 11C, the transmitting UE transmits the SL data using the four subchannels 1141, 1142, 1143, and 1144 in the initial transmission, but transmits the SL data using the three subchannels 1151, 1152, and 1153 in the first retransmission. In addition, in the second retransmission, the transmitting UE transmits the SL data using the four subchannels 1161, 1162, 1163, and 1164.

As described above, when SL data is transmitted based on I-RBs, the number of PRBs may vary between initial transmission and retransmission.

To summarize what has been described above, regardless of the C-RB based configuration described in FIGS. 11A and 11B or the I-RB based configuration described in FIG. 11C, the number of PRBs used for initial transmission and the number of PRBs used for retransmission for one TB may be different from each other.

Therefore, since the number of PRBs for initial transmission and the number of PRBs for retransmission may be different due to a GB not only in C-RB based transmission but also in I-RB based transmission, an appropriate TBS calculation method is needed.

Since a TBS may vary due to different numbers of PRBs as described above, the present disclosure proposes a TBS calculation method as follows.

(1) When some of frequency resources (a portion of a subchannel) of initial transmission or retransmission, which are determined by the transmitting UE for TB transmission, are included in a GB, the transmitting UE may or may not exclude PRBs included in the GB in determining the number of PRBs for TBS calculation.

A. Whether or not PRBs belonging to the GB are excluded in TBS calculation may be preconfigured, or may be informed by the transmitting UE to the receiving UE through SCI or MAC CE. In case that whether to exclude PRBs belonging to the GB is preconfigured or informed by the transmitting UE to the receiving UE through SCI or MAC CE, only one bit of information may be used to notify whether to exclude the PRBs belonging to the GB. This is because the position where the GB is allocated is generally fixed, so each of the transmitting UE and the receiving UE knows the number of PRBs in the subchannel which overlap with the GB.

(2) When the PRBs belonging to the GB are excluded in TBS calculation, the transmitting UE and receiving UE may determine the number PRB_{TBS} of PRBs for TBS calculation using any one of Equations 5 to 8 below.

PRB_{TBS}=min(PRB₁,PRB₂, . . . , PRB_{N}) [Equation 5]

In Equation 5, PRBₙ indicates the number of PRBs (excluding PRBs in the GB) allocated for the n-th transmission. For example, PRB₁ and PRB₂ represent the number of PRBs allocated for initial transmission and first retransmission, respectively. Therefore, according to Equation 5, the transmitting UE may determine the number of PRBs for a case where it has the smallest number of PRBs among initial transmission and retransmission as the number PRB_{TBS} of PRBs in TBS calculation.

PRB_{TBS}=max(PRB₁,PRB₂, . . . , PRB_{N}) [Equation 6]

Equation 6 may correspond to the opposite of Equation 5. In other words, according to Equation 6, the transmitting UE may determine the number of PRBs for a case where it has the largest number of PRBs among initial transmission and retransmission as the number PRB_{TBS} of PRBs in TBS calculation.

PRB_{TBS}=average(PRB₁,PRB₂, . . . , PRB_{N}) [Equation 7]

Equation 7 may correspond to a case where the number PRB_{TBS} of PRBs in TBS calculation is determined by calculating an average of the number of PRBs in the initial transmission and the number of PRBs in each retransmission. In Equation 7, average(⋅) may correspond to one of various average calculation schemes.

PRB_{TBS}=PRB₁ [Equation 8]

Equation 8 may correspond to a method of determining the number of PRBs in initial transmission as the number PRB_{TBS} of PRBs in TBS calculation.

It should be noted that the third exemplary embodiment described above may be applied together with the first and second exemplary embodiments described above.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a first user equipment (UE), comprising:
receiving a downlink (DL) reference signal transmitted by a base station using a beam included in a beam candidate group to be used for sidelink (SL) communication with a second UE;
measuring a DL reference signal received power (RSRP) of the DL reference signal;
determining a transmit power of a beam included in the beam candidate group based on the measured DL RSRP; and
transmitting SL data to the second UE with the determined transmit power.

2. The method according to claim 1, further comprising:
transmitting an SL reference signal to the second UE; and
receiving information on an SL RSRP for the SL reference signal from the second UE,
wherein the information on the SL RSRP received from the second UE is further considered in determining the transmit power of the beam included in the beam candidate group.

3. The method according to claim 1, wherein when the beam candidate group includes a plurality of beams, the measuring of the DL RSRP further comprises: measuring DL RSRP(s) for all beams included in the beam candidate group or one or more beams from the beam candidate group, measuring a DL RSRP for an arbitrary one beam selected among the beams included in the beam candidate group, measuring a DL RSRP of a beam most recently used in SL communication, or measuring a DL RSRP for a beam to be used for the SL communication.

4. The method according to claim 1, wherein in the measuring of the DL RSRP using the beam included in the beam candidate group, measurement is performed within a (pre-)configured measurement window.

5. The method according to claim 1, wherein in the measuring of the DL RSRP using the beam included in the beam candidate group within a preconfigured measurement window, when a number of RSRP measurements of the DL reference signal is less than a pre-configured number, transmit powers of beams included in the beam candidate group are determined by using a pre-configured DL path loss (PL) value or a most recently applied DL PL value.

6. The method according to claim 1, further comprising:
determining whether multi-consecutive slot transmission (MCSt) is to be performed based on a Listen-Before-Talk (LBT) procedure during SL communication with the second UE in an unlicensed band;
in response to determining to perform the MCSt, determining a number of transport blocks (TBs) to be transmitted in consecutive slots;
identifying whether flexible symbols of each slot are allocatable as a resource for transmitting the TB(s) when performing the MCSt; and
in response to determining that the flexible symbols are allocatable, transmitting the TB(s) to the second UE using at least a portion of the flexible symbols,
wherein the flexible symbols include a guard symbol of a first slot and an automatic gain control (AGC) symbol of a second slot when the first slot and the second slot are temporally consecutive in performing the MCSt.

7. The method according to claim 6, wherein a case when the flexible symbols are allocatable corresponds to a case when first SL data to be transmitted by the first UE has a higher priority than a predetermined threshold priority.

8. The method according to claim 6, wherein a case when the flexible symbols are not allocatable corresponds to a case when a data priority of a TB transmitted by a neighboring third UE is higher than a priority of the first SL data.

9. The method according to claim 6, wherein when performing the MCSt, a reference position of a second starting symbol in the first slot is preconfigured by higher layer signaling.

10. The method according to claim 6, wherein when the flexible symbols are included in the resource for transmitting the TB, a size of the TB (TBS) is calculated including the flexible symbols.

11. The method according to claim 6, further comprising, when at least one subchannel among one or more subchannels through which the TB is transmitted overlaps with at least a portion of a guard band (GB), determining a size of the TB (TBS) by including a size of physical resource blocks (PRBs) included in the GB in calculating the TBS.

12. A first user equipment (UE) comprising a processor,
wherein the processor causes the first UE to perform:
receiving a downlink (DL) reference signal transmitted by a base station using a beam included in a beam candidate group to be used for sidelink (SL) communication with a second UE;
measuring a DL reference signal received power (RSRP) of the DL reference signal;
determining a transmit power of a beam included in the beam candidate group based on the measured DL RSRP; and
transmitting SL data to the second UE with the determined transmit power.

13. The first UE according to claim 12, wherein the processor further causes the first UE to perform:
transmitting an SL reference signal to the second UE; and
receiving information on an SL RSRP for the SL reference signal from the second UE,
wherein the information on the SL RSRP received from the second UE is further considered in determining the transmit power of the beam included in the beam candidate group.

14. The first UE according to claim 12, wherein when the beam candidate group includes a plurality of beams, in the measuring of the DL RSRP, the processor further causes the first UE to perform: measuring DL RSRP(s) for all beams included in the beam candidate group or one or more beams from the beam candidate group, measuring a DL RSRP for an arbitrary one beam selected among the beams included in the beam candidate group, measuring a DL RSRP of a beam most recently used in SL communication, or measuring a DL RSRP for a beam to be used for the SL communication.

15. The first UE according to claim 12, wherein in the measuring of the DL RSRP using the beam included in the beam candidate group within a pre-configured measurement window, the processor further causes the first UE to perform, when a number of RSRP measurements of the DL reference signal is less than a pre-configured number, determining transmit powers of beams included in the beam candidate group by using a pre-configured DL path loss (PL) value or a most recently applied DL PL value.

16. The first UE according to claim 12, wherein the processor further causes the first UE to perform:
determining whether multi-consecutive slot transmission (MCSt) is to be performed based on a Listen-Before-Talk (LBT) procedure during SL communication with the second UE in an unlicensed band;
in response to determining to perform the MCSt, determining a number of transport blocks (TBs) to be transmitted in consecutive slots;
identifying whether flexible symbols of each slot are allocatable as a resource for transmitting the TB(s) when performing the MCSt; and
in response to determining that the flexible symbols are allocatable, transmitting the TB(s) to the second UE using at least a portion of the flexible symbols,
wherein the flexible symbols includes a guard symbol of a first slot and an automatic gain control (AGC) symbol of a second slot when the first slot and the second slot are temporally consecutive in performing the MCSt.

17. The first UE according to claim 16, wherein a case when the flexible symbols are allocatable corresponds to a case when first SL data to be transmitted by the first UE has a higher priority than a predetermined threshold priority.

18. The first UE according to claim 16, wherein a case when the flexible symbols are not allocatable corresponds to a case when a data priority of a TB transmitted by a neighboring third UE is higher than a priority of the first SL data.

19. The first UE according to claim 16, wherein the processor further causes the first UE to perform, when at least one subchannel among one or more subchannels through which the TB is transmitted overlaps with at least a portion of a guard band (GB), determining a size of the TB (TB S) by including a size of physical resource blocks (PRBs) included in the GB in calculating the TBS.

20. The first UE according to claim 16, wherein the processor further causes the first UE to perform, when the flexible symbols are included in the resource for transmitting the TB, calculating a size of the TB (TBS) including the flexible symbols.
